(19) United States
(12) Patent Application Publication
(10) Pub. No.: US 2026/0237535 A1
(43) Pub. Date: Aug. 13, 2026

(54) Isotope Generator System and Method of Generating Isotope

(71) Applicant: TAG1 Inc., Chesterfield, MO (US)

(72) Inventors: Sterling Marshall, Chesterfield, MO (US); Greg Bushman, Chesterfield, MO (US); John Schmitz, Chesterfield, MO (US); Clement Cheung, Vancouver (CA); Sumit Verma, Chesterfield, MO (US); Cristian Antonio Wieczorek Villas Boas, St. Louis, MO (US)

(21) Appl. No.: 19/437,937

(22) Filed: Dec. 31, 2025

Related U.S. Application Data
(60) Provisional application No. 63/740,706, filed on Dec. 31, 2024.

(51) Int. Cl. G21G 4/10; G21G 4/08

(52) U.S. Cl. CPC G21G 4/10; G21G 4/08

(57) ABSTRACT

An isotope generator system and isotope generator produce isotope for Targeted Alpha Therapy (TAT) from a parent isotope. Gaseous parent isotope is entrained in flowing gas via a fluid mover and delivered to a decay chamber. The parent isotope decays into the isotope for TAT in the decay chamber, which may also include the daughter isotope of the TAT isotope. The isotope for TAT is then evacuated from the decay chamber via the fluid mover. Any daughter isotope may also be evacuated. The decay chamber and fluid mover may include a piston pump. The system is automated using a controller that controls operation of valve and piston actuators.

### CROSS-REFERENCE TO RELATED APPLICATIONS

The present application claims the benefit of U.S. Provisional Application Ser. No. 63/740,706, filed Dec. 31, 2024, the entirety of which is hereby incorporated by reference.

### FIELD OF THE DISCLOSURE

The present disclosure generally relates to an isotope generator system, an isotope generator, and a method of generating an isotope, such as a generator for generating an isotope for Targeted Alpha Therapy (TAT), such as Lead-212, and a method of generating the isotope for TAT, such as Lead-212.

### BACKGROUND OF THE DISCLOSURE

Existing generators for producing Lead-212 (²¹²Pb) isotopes are column-based generators that employ source isotopes such as Thorium-228 (²²⁸Th) and/or Radium-224 (²²⁴Ra) that are adsorbed onto a cation exchange resin in an exchange column from which the Lead-212 and/or Bismuth-212 (²¹²Bi) isotopes are recovered from the resin. However, while generators that employ a Thorium-228 source isotope can provide a long-term supply of Lead-212 and Bismuth-212 isotopes, these generators have well known problems.

Thorium-228 generators are high-activity generators that can cause radiolytic failure in the generator columns over time and may release high energy contaminates (breakthrough) into the Lead-212 and/or Bismuth-212 solutions recovered from these columns. Contaminants in the recovered Lead-212 and/or Bismuth-212 solutions have the potential to create deleterious radiation doses.

Existing Thorium-228 generators also experience characteristic decreases in radon yields over time due to radiolytic breakdown of organic capture materials, such as barium stearate used to contain the isotope sources. Severe contamination can also result if a breach in the generator column takes place due to prolonged radiolysis by the high energy source isotopes.

Exchange resins used in these generators are also prone to radiolytic breakdown that can result in breakthrough of Radium-224 isotopes from the generator column that contaminate solutions containing the recovered Lead-212 and/or Bismuth-212 isotopes. This can also result in unnecessary or unacceptable radiation doses for the patient, especially due to high gammas from Thallium-208 (²⁰⁸Tl).

These generators may also have low Lead-212 and/or Bismuth-212 yields due to gaseous diffusion of the intermediate noble gas Radon-220 (²²⁰Rn) deep into the exchange resin beads.

### SUMMARY OF THE DISCLOSURE

Features of an isotope generator system, an isotope generator, an emanation chamber, and a method of generating an isotope are described and shown herein.

In one aspect, an isotope generator system for producing Pb-212 for Targeted Alpha Therapy (TAT) from a parent isotope generally comprises: an emanation chamber configured to hold the parent isotope therein; an isotope collection container; and an isotope generator including at least one fluid mover and at least one decay chamber, each in selective fluid communication with the emanation chamber and the isotope collection chamber. The at least one fluid mover is configured to selectively generate gas flow from the emanation chamber to the at least one decay chamber, whereby a gaseous daughter intermediary isotope from the parent isotope in the emanation chamber is entrained in the gas flow and delivered into the decay chamber. The at least one decay chamber is configured to retain a gaseous intermediary daughter isotope therein to enable decay of the gaseous intermediary daughter isotope to Pb-212 and its daughter isotope. The at least one fluid mover is configured to selectively generate at least one of gas flow or liquid flow from the at least one decay chamber to the isotope collection chamber to deliver Pb-212 and its daughter isotope in the decay chamber into the isotope collection chamber.

In another aspect, an isotope generator for producing an isotope for Targeted Alpha Therapy (TAT) from a parent isotope generally comprises at least one fluid mover configured to be in selective fluid communication with an emanation chamber holding the parent isotope therein; and at least one decay chamber in selective fluid communication with the emanation chamber. The at least one fluid mover is configured to selectively generate gas flow from the emanation chamber to the at least one decay chamber, whereby a gaseous daughter isotope from the parent isotope in the emanation chamber is entrained in the gas flow and delivered into the at least one decay chamber. The at least one decay chamber is configured to retain a gaseous intermediary daughter isotope therein to enable decay of the gaseous intermediary daughter isotope to the isotope for TAT and its daughter isotope. The at least one fluid mover is configured to selectively generate fluid flow so that the isotope for TAT and its daughter isotope in the at least one decay chamber is evacuated from the at least one decay chamber.

In yet another aspect, a method for producing Pb-212 for Targeted Alpha Therapy (TAT) from a parent isotope generally comprises selectively generating gas flow, using at least one fluid mover, from an emanation chamber holding the parent isotope to at least one decay chamber so that a gaseous intermediary daughter isotope emanating from the parent isotope in the emanation chamber is entrained in the gas flow and delivered into the at least one decay chamber; retaining the gaseous daughter isotope within the at least one decay chamber for a selective amount of time so that the gaseous daughter isotope decays to Pb-212 and its daughter isotope; and selectively generating fluid flow, using the at least one fluid mover, from the at least one decay chamber to an isotope collection chamber so that Pb-212 and its daughter isotope in the decay chamber is evacuated from the at least one decay chamber.

In another aspect, an emanation chamber defines an interior cavity sized and shaped to receive a parent isotope coupon therein. The emanation chamber defines inlet and outlet emanation flow channels in communication with the interior cavity. The inlet and outlet emanation flow channels direct gas across (e.g., tangential to) the parent isotope coupon so that the intermediary daughter isotope (e.g., gaseous isotope) emanating from the parent isotope is taken up or entrained in a generated gas flow and exits the emanation chamber through the outlet emanation flow channel and enters an isotope generator. The emanation chamber may be selectively coupled to and removable from the isotope generator for replacing the parent isotope coupon.

In yet another embodiment, the isotope generator system, the isotope generator, and the method of generating a desired isotope may be used to generate other isotopes, other than Lead-212 for example, including other isotopes for Targeted Alpha Therapy (TAT). Thus, unless specified in issued claims, the embodiments of the invention are not necessarily limited to the isotopes disclosed in the description or the original claims.

### BRIEF DESCRIPTION OF THE DRAWINGS

FIG. 1 is a schematic illustration of an automated isotope generator system of the present disclosure, including an emanation chamber, an isotope generator, and an isotope collection container.

FIG. 2 is a diagram of the isotope generator system, further including a drying agent (or dehumidifier) and an air filter for respectively dehumidifying and filtering ambient air entering the generator system.

FIG. 3 is an enlarged perspective of the emanation chamber.

FIG. 4 is an exploded view of the emanation chamber, with the two parts of the chamber separated.

FIG. 5 is an enlarged side elevation of a parent isotope coupon.

FIG. 6 is a perspective of the isotope generator system including a housing of the isotope generator.

FIG. 7 is similar to FIG. 6, with a front panel of the generator housing removed to shown generator components.

FIG. 8 is a diagram of a controller of the generator and components in communication with the controller.

FIG. 9A is a diagram of the isotope generator system illustrating a gas flow path through the system.

FIG. 9B is a schematic illustrating a portion of the generator including one piston pump and associated distribution valve.

FIG. 9C is similar to FIG. 9B, except showing a flow path through the distribution valve from the emanation chamber into a decay chamber or barrel of the piston pump.

FIG. 9D is similar to FIG. 9B, except showing a flow path through the distribution valve from a solvent source into the decay chamber or barrel of the piston pump.

FIG. 9E is similar to FIG. 9B, except showing a flow path through the distribution valve from the decay chamber or barrel of the piston pump to a collection container.

FIG. 10 is a control operational timeline for isotope production operations of the isotope generator.

FIG. 11 is a schematic of an isotope production operation of the isotope generator.

FIG. 12 is a schematic of an isotope production operation of the isotope generator.

FIG. 13 is a schematic of an isotope production operation of the isotope generator.

FIG. 14 is a schematic of an isotope production operation of the isotope generator.

FIG. 15 is a rinse operational timeline for rinsing of the isotope generator.

FIG. 16 is a schematic of a rinsing operation of the isotope generator.

FIG. 17 is a schematic of a rinsing operation of the isotope generator.

FIG. 18 is a schematic of a rinsing operation of the isotope generator.

FIG. 19 is a schematic of a rinsing operation of the isotope generator.

FIG. 20 is a schematic of a rinsing operation of the isotope generator.

FIG. 21 is a schematic of a pre-generation setup for another embodiment or method of generating an isotope.

FIG. 22 is a schematic of a pre-generation process for pre-loading the decay chambers or barrels of the piston pumps with solvent or eluent.

FIG. 23 is a schematic of a step for desired isotope (e.g., Lead-212) generation.

FIG. 24 is a schematic of a step for desired isotope (e.g., Lead-212) generation.

FIG. 25 is a schematic of a step for rinsing of the generator with solvent or eluent to extract the desired isotope (e.g., Lead-212) from the generator, including flow paths of the isotope in the generator, to produce the isotope solution or eluate.

FIG. 26 is a schematic of a step for rinsing of the generator with solvent or eluent to extract the desired isotope (e.g., Lead-212) from the generator, including flow paths of the isotope in the generator, to produce the isotope solution or eluate.

FIG. 27 is a schematic of a step for rinsing of the generator with solvent or eluent to extract the desired isotope (e.g., Lead-212) from the generator, including flow paths of the isotope in the generator, to produce the isotope solution or eluate.

FIG. 28 is a schematic of a step for rinsing of the generator with solvent or eluent to extract the desired isotope (e.g., Lead-212) from the generator, including flow paths of the isotope in the generator, to produce the isotope solution or eluate.

FIG. 29 is a schematic of a step for rinsing of the generator with solvent or eluent to extract the desired isotope (e.g., Lead-212) from the generator, including flow paths of the isotope in the generator, to produce the isotope solution or eluate.

FIG. 30 is a schematic of a step for rinsing of the generator with solvent or eluent to extract the desired isotope (e.g., Lead-212) from the generator, including flow paths of the isotope in the generator, to produce the isotope solution or eluate.

FIG. 31 is a schematic of a step for rinsing of the generator with solvent or eluent to extract the desired isotope (e.g., Lead-212) from the generator, including flow paths of the isotope in the generator, to produce the isotope solution or eluate.

FIG. 32 is a schematic of a step for rinsing of the generator with solvent or eluent to extract the desired isotope (e.g., Lead-212) from the generator, including flow paths of the isotope in the generator, to produce the isotope solution or eluate.

FIG. 33 is an exemplary graph depicting a timing sequence for a controller executing an isotope generation process described in Example 3.

### DETAILED DESCRIPTION OF THE DISCLOSURE

The present disclosure is generally directed to an isotope generator system for producing a terminally sterilized, desired isotope. In a particular example, the isotope generator system is specifically designed and constructed to produce Pb-212 a beta-emitter isotope and may also produce its daughters Bi-212 (an alpha emitting isotope) and Tl-208 (beta emitting isotope). Pb-212 and Bi-212 are candidates for radioligand therapy for combining beta and alpha emission for Targeted Alpha Therapy (TAT) in medical treatments against cancer for example. TAT is based on the coupling of alpha particle-emitting isotopes, such as Lead-212, to tumor-selective carrier molecules, such as monoclonal antibodies or peptides. As used herein, a “TAT isotope” is an isotope that is suitable for use in Targeted Alpha Therapy in medical treatments. For example, Lead-212 is a TAT isotope because it decays into Bismuth-212, which is an alpha-emitting isotope, in vivo.

The illustrated isotope generator for producing Lead-212 isotope (or another desired isotope) can be considered “active,” in that negative pressure (e.g., vacuum) is generated to draw a gaseous intermediary daughter isotope from an emanation chamber containing a parent isotope (e.g., solid parent isotope) into a separate decay chamber to enable the intermediary daughter isotope to further decay into the desired isotope (e.g., Lead-212 or another TAT isotope). As used herein, the “parent isotope” is the source isotope or starting isotope material from which the generator enables decay to the desired isotope. In one embodiment, the daughter isotope (e.g., Bismuth-212) of the desired isotope (e.g., Lead-212) may also be present. Further, after enabling the intermediary daughter isotope to decay into the desired isotope (and its daughter isotope in one embodiment), the isotope generator produces a positive pressure within the decay chamber to evacuate the decay chamber and force the desired isotope (and its daughter isotope when present) out of the decay chamber, which may then enter into a separate collection container or may be delivered directly to another system or another component of the generator system. In one embodiment, the desired isotope and its daughter isotope may be collected in solvent or eluate in the collection container.

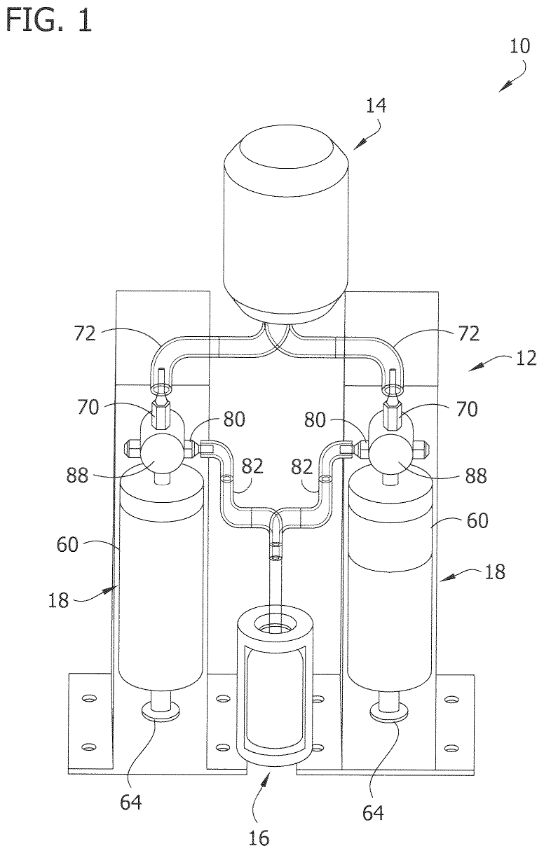

Referring to FIG. 1, a schematic illustration of one embodiment of an automated isotope generator system is generally indicated at reference numeral 10. In general, the isotope generator system 10 includes an isotope generator, generally indicated at 12; an emanation chamber, generally indicated at 14, configured to contain or hold a parent isotope (e.g., Radium-224) therein and configured to be removably coupled to the isotope generator; and an isotope collection container, generally indicated at 16, removably coupled to the isotope generator and configured to receive and contain the desired isotope and its daughter isotope(s) generated from the isotope generator. In general, the isotope generator 12 is configured to generate gas flow (e.g., air flow) through the emanation chamber 14 to entrain the emanated gaseous daughter isotope in the gas flow and deliver it to the isotope generator. As explained in more detail below, the isotope generator 12 includes at least one fluid mover, generally indicated at 18, in selective fluid communication with the emanation chamber and configured to produce the gas flow through the emanation chamber and entrain the intermediary daughter isotope (e.g., Radon-220) therein. The fluid mover 18 may be configured to move both gas and liquid, or may be configured to move only gas. Moreover, the fluid mover 18 may comprise more than one mover, including an embodiment where there are separate types of fluid movers: one type for moving gas, and one type for moving liquid. In the illustrated embodiment, as explained in more detail below, the fluid mover 18 comprises piston pumps (e.g., syringe pumps) configured to move both gas and liquid. Other types of fluid movers including other types of pumps may be used.

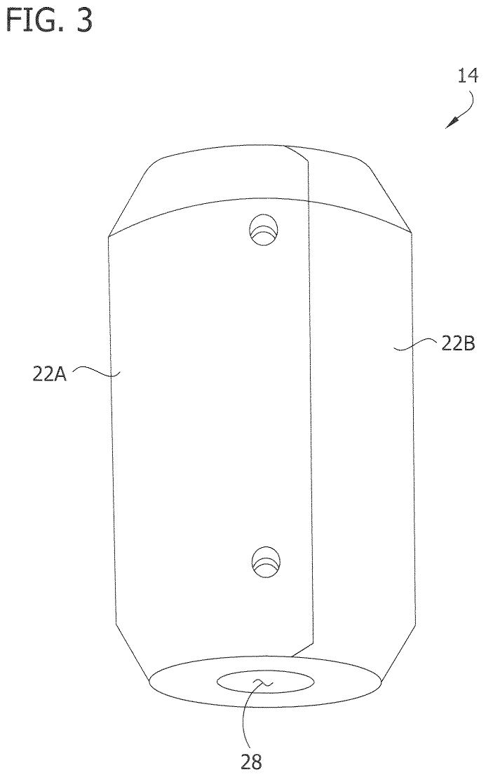

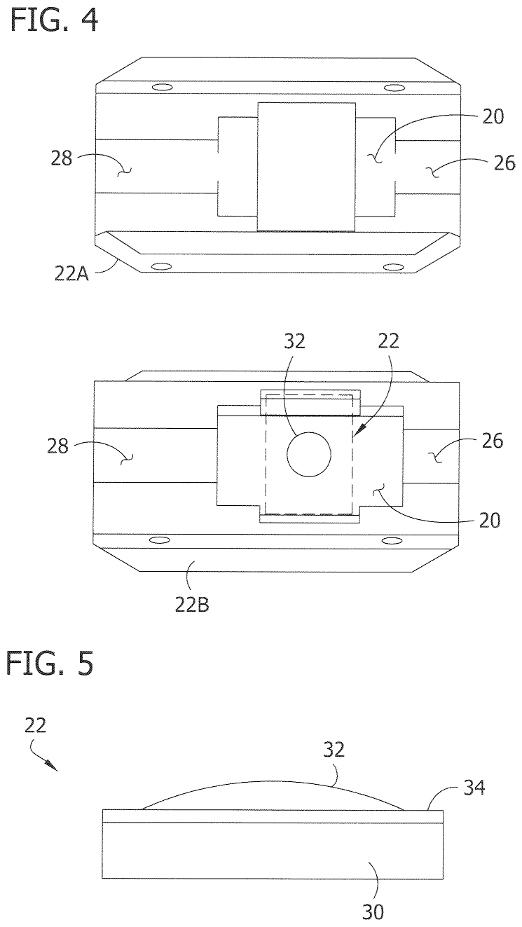

Referring to FIGS. 3 and 4, the emanation chamber 14 defines an interior cavity 20 sized and shaped to receive a parent isotope coupon 22 therein. The emanation chamber 14 may comprise (e.g., formed from) tungsten, lead, or other material to inhibit radiation from emanating outside the emanation chamber. The illustrated emanation chamber 14 includes first and second chamber portions 22A, 22B that are removably coupled to one another to enable insertion of the coupon 22 in the interior cavity 20. The emanation chamber 14 defines inlet and outlet emanation flow channels 26, 28, respectively, in communication with the interior cavity 20. As shown in FIGS. 4 and 5, the illustrated parent isotope coupon 22 includes a substrate 30 and the parent isotope 32 (e.g., Radium 226) disposed on at least one surface of the substrate. In one example, the substrate 30 is generally planar and the parent isotope 32 is applied to a surface of the substrate so that the isotope permanently or firmly binds to the substrate. The substrate 30 may include an oxide layer 34 on which the parent isotope 32 is disposed to inhibit absorption of the parent isotope and its intermediary daughter isotope (e.g., Radon-224) in the substrate.

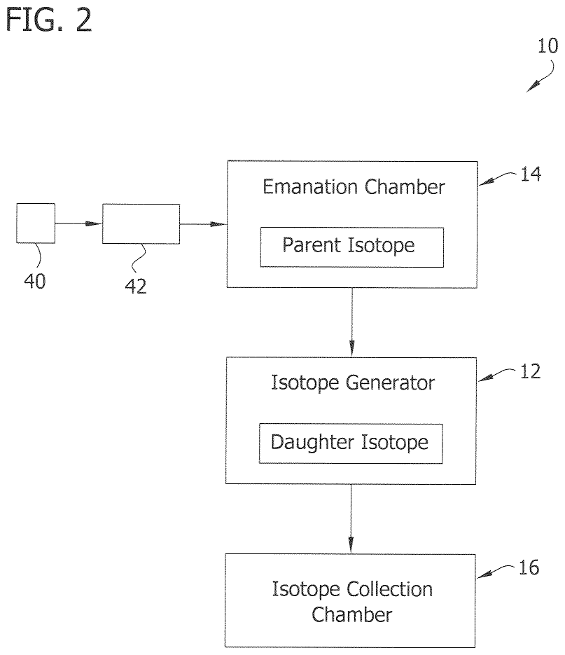

The inlet and outlet emanation flow channels 26, 28 direct gas (e.g., ambient air) across (e.g., tangential to) the parent isotope 32 on the substrate 30 so that the intermediary daughter isotope (e.g., gaseous isotope) emanating from the parent isotope is taken up or entrained in a generated gas flow and exits the emanation chamber 14 through the outlet emanation flow channel 28 and enters the isotope generator 12. The inlet flow channel 26 includes one or more flow channels having an upstream end in fluid communication with a source of gas or atmosphere for delivering the gas (e.g., ambient air). In the illustrated example where ambient air is used as the gas, the air may be dehumidified and/or filtered to remove moisture and/or contaminates, respectively, from the air. In one example, as shown in FIG. 2, ambient air may flow through a suitable drying agent 40 (e.g., molecular sieve, calcium carbonate, silica gel, etc.) and/or an air filter 42 (e.g. activated carbon) upstream of the inlet flow channel 26 before entering the emanation chamber 14. In an example where a separate gas source is used, the gas may be an inert gas or other gas contained within a container and substantially free from impurities and/or moisture, or the gas container may be upstream of a similar drying agent and/or filter.

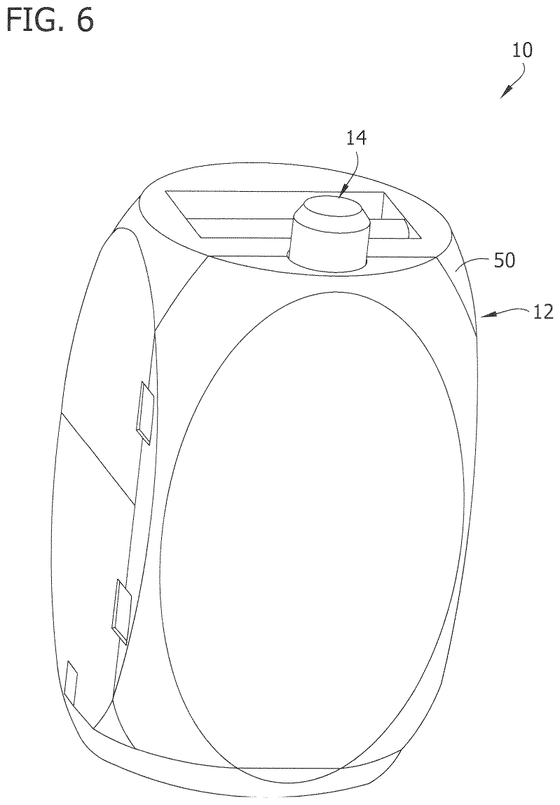

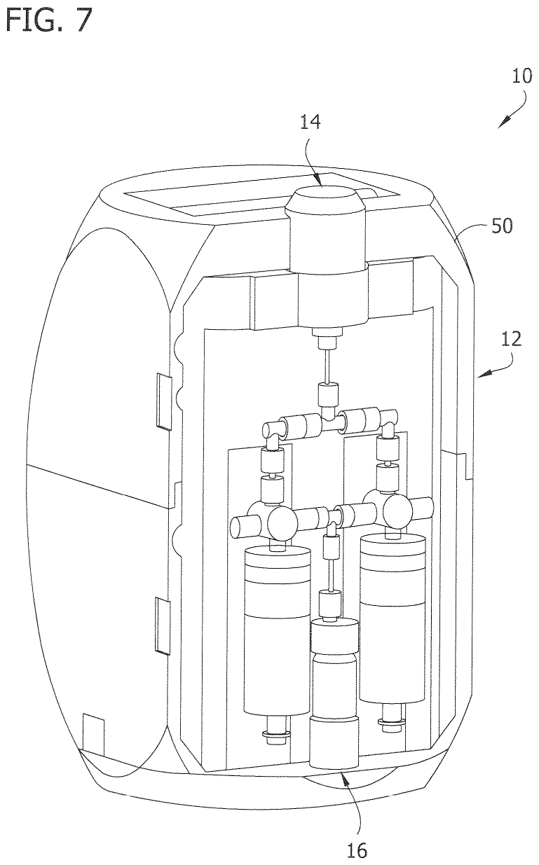

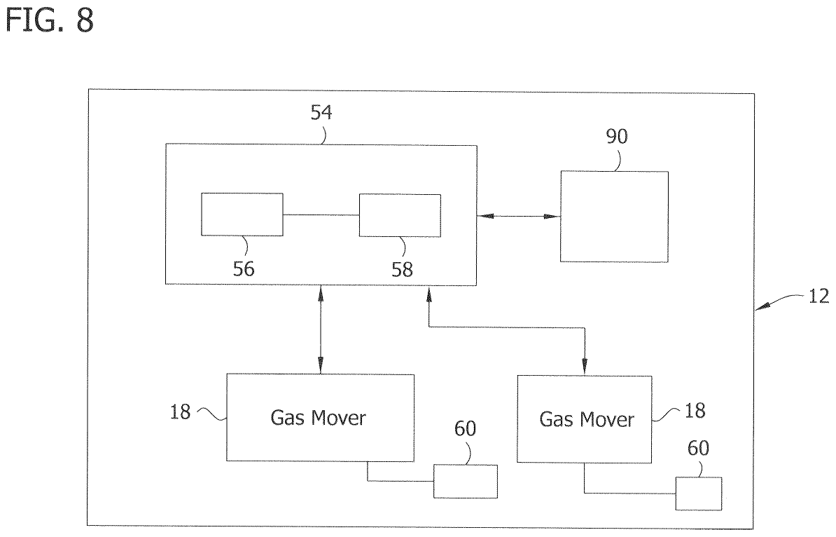

As shown in FIGS. 6-8, the components of the illustrated generator 12 are contained within or coupled to a generator housing 50. As explained in more detail below and shown schematically in FIG. 8, the illustrated isotope generator 12 includes a controller 54, including a processor 56 in communication with memory 58, for controlling operation of the generator. The controller 54 may be disposed within the generator housing 20. The controller 54 controls operation of the fluid mover 18, and in a particular embodiment, controls operation of each fluid mover of a plurality of fluid movers to efficiently generate the desired isotope. In addition, the isotope generator 12 further includes at least one decay chamber 60 configured to receive, via the fluid mover, the gas flow including the entrained intermediate daughter isotope from the emanation chamber 14. As explained in more detail below, the decay chamber 60 enables the intermediary daughter isotope(s) (e.g., Radon-224) to decay to the desired isotope (e.g., Lead-212) therein. A portion of the volume of the daughter isotope (e.g., Lead-212) may decay in the decay chamber 60 into at least one daughter isotope (e.g., Bi-212, an alpha emitting isotope), which in turn may decay into one or more granddaughter isotope (e.g., Tl-208, a beta emitting isotope). In the illustrated embodiment, the generator 12 includes more than one fluid mover 18 and more than one decay chamber 60 (e.g., two fluid movers and two decay chambers). In general, the controller 54 may automatically operate the generator 12 based on input from the user. For example, the user may simply input or select instructions to run the system 10 to generate a certain quantity of desired isotope (e.g., Lead-212). This may be communicated to the controller 54 through the user interface (e.g., interface 90) or remotely via a wireless communication, examples of which are described below. Thus, the generator system 10 may be used in production environments, such as hot cells, while minimizing human interaction.

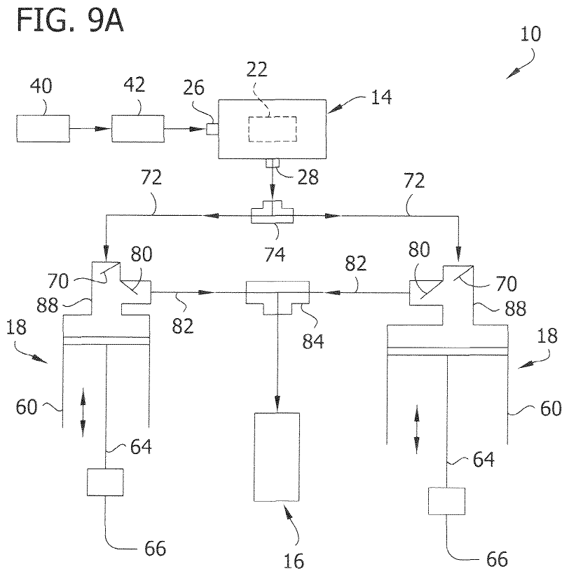

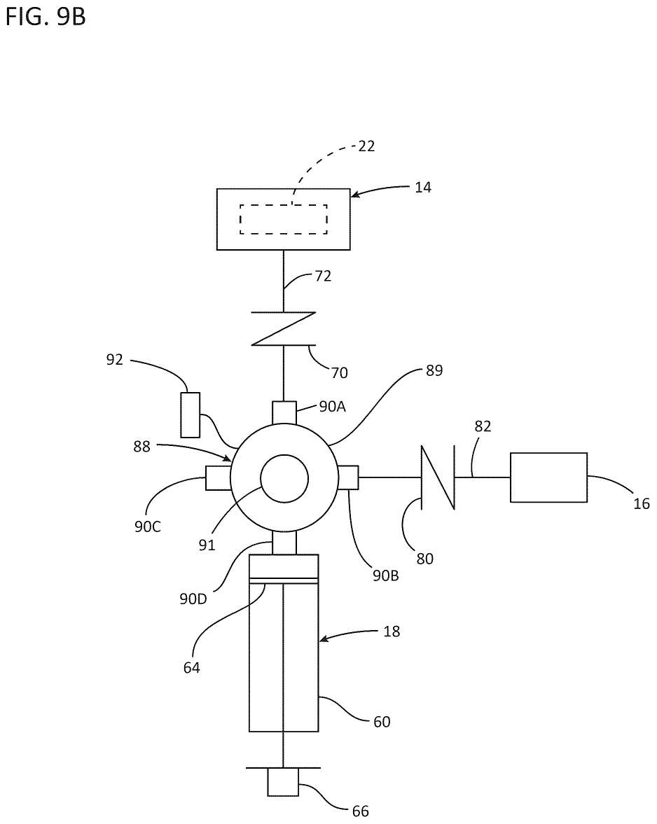

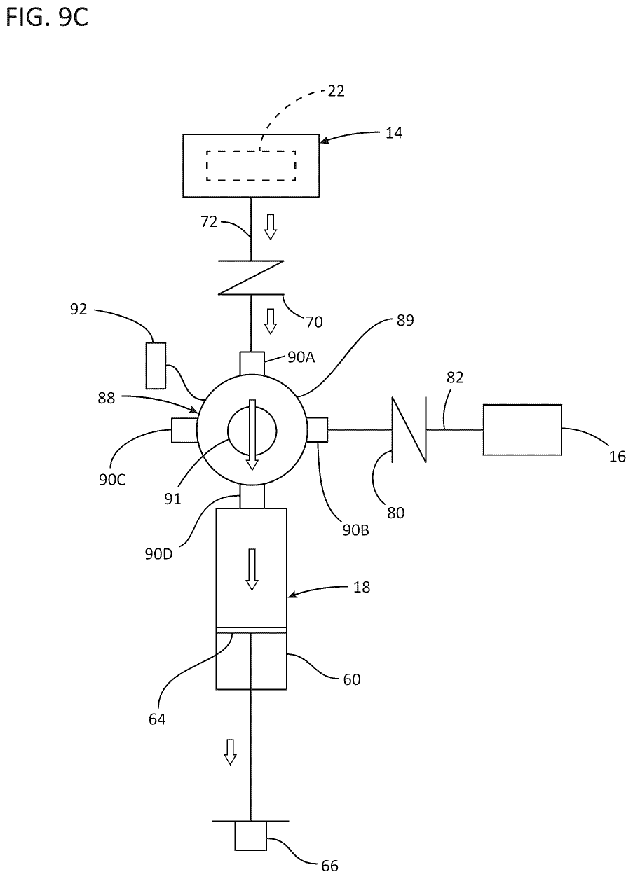

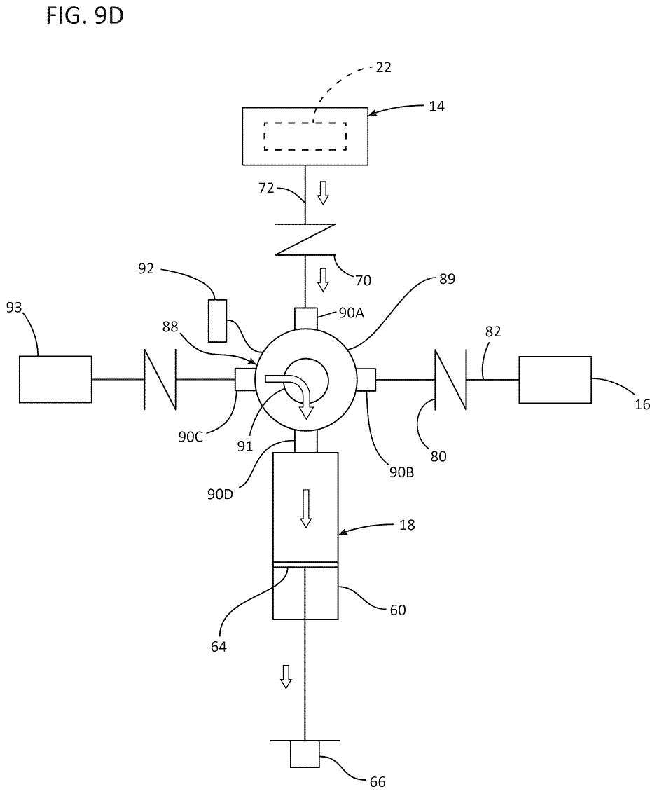

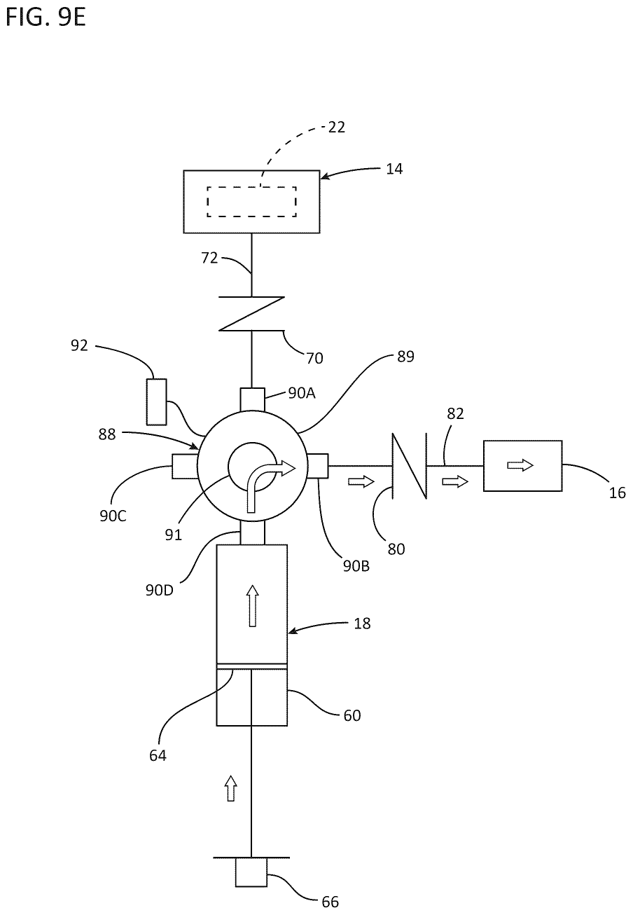

As shown in FIGS. 1 and 9, in the illustrated embodiment, each associated fluid mover 18 and decay chamber 60 are integral parts of a piston pump (e.g., syringe pump; indicated by same reference numeral as fluid mover), whereby the piston pump functions as both the fluid mover, configured to move both gas and fluid, and the decay chamber. The piston pump 18 includes a reciprocating piston 64 received in a barrel 60 (e.g., 50 mL barrel comprising borosilicate glass) functioning as the decay chamber. A piston actuator 66 drives linear, reciprocating movement of the piston 64 within the barrel 60. The piston actuator 66 may be controlled by the controller 54 according to processor-readable instructions stored in memory. Moving the piston 64 away from a head of the barrel 60 creates negative pressure in the barrel, which in turn, creates gas flow in the emanation chamber 14 and draws ambient air and the entrained intermediary daughter isotope into the barrel. Subsequently, moving the piston toward the head of the barrel 60 creates positive pressure in the barrel, which in turn evacuates the gas and the desired isotope from the barrel 60. In one embodiment, the fluid mover 18 (e.g., piston pump) also evacuates liquid. For example, a solution of the desired TAT isotope—such as a solution of Lead-212 (and its daughter isotope) and a suitable liquid solvent (e.g., HCl or another acid or another liquid)—may be present in the decay chamber 60. This solution may be present in the decay chamber 60 in addition to the isotope (e.g., Lead-212) and its daughter isotope entrained in the gas in the chamber. In one example, the desired isotope for TAT and its daughter are delivered into the isotope collection container 16. The volume collected in the isotope collection container 16 may include other isotopes other than the desired daughter (e.g., Lead-212) and its daughter isotope (e.g., Bi-212, an alpha emitting isotope), including one or more granddaughter isotopes (e.g., Tl-208, a beta emitting isotope) of the desired daughter TAT isotope.

In another example, the isotope for TAT (e.g., Lead-212) is delivered directly to another system for further processing, including but not limited to a synthesizer or one or more systems for purification, radiolabeling a targeting vector, which may include a chelator, and/or other processes suitable for forming a TAT radiopharmaceutical. The daughters of the isotope for TAT may also be included with the isotope for TAT. For example, along with Lead-212, Bi-212, an alpha emitting isotope, and/or Tl-208, a beta emitting isotope, may be collected or directly delivered to another system for further processing.

As shown in FIG. 9A, the outlet emanation flow channel 28 is fluidly connected to one or more inlet valves 70, which are in turn, fluidly connected to respective one or more decay chambers or barrels 60. In the illustrated embodiment, the outlet emanation flow channel 28 is fluidly connected to two separate inlet valves 70 associated with two respective decay chambers 60 via dedicated inlet conduits 72 (e.g., inlet tubing). The inlet conduits may be formed from an inert polymer (e.g., PEEK, polypropylene, polyurethane, etc.). A connector 74 (e.g., Y-connector) or a valve may be used to fluidly connect the outlet emanation flow channel 28 to the separate inlet conduits 72.

Referring still to FIG. 9A, each decay chamber 60 is fluidly connected to an outlet valve 80, which is in turn fluidly connected to the downstream collection container 16. In the illustrated embodiment, each outlet valve 80 is fluid connected to the collection chamber via dedicated outlet conduits 82 (e.g., outlet tubing). The outlet conduits 82 may be formed from an inert polymer (e.g., PEEK, polypropylene, polyurethane, etc.). A connector 84 (e.g., Y-connector) or a valve may be used to fluidly connect separate outlet conduits 82 to the collection container 16.

In the embodiment shown in FIG. 9A, the inlet and outlet valves 70, 80 associated with each piston pump 18 may be part of a valve block 88 defining flow paths in communication with the decay chamber 60, or may be separate from one another. In one embodiment, each of the inlet and outlet valves 70, 80 may comprises a check valve or one-way valve. Each inlet check valve 70 enables gas to flow downstream into the decay chamber 60 (e.g., under the negative pressure of the pump), and inhibits gas flow upstream from the decay chamber into the inlet conduit 72. Each outlet check valve 80 enables gas flow downstream into the collection container 16 (e.g., under positive pressure of the pump), and inhibits gas from flowing upstream from the outlet conduit 82 and the collection container 16 into the decay chamber 60. In one example, the inlet and outlet valves 70, 80 may comprise PEEK or other inert polymer or material.

Referring to FIGS. 9B-9E, in one embodiment, each valve block 88 is an actuatable distribution valve coupled to the corresponding piston pump 18 (e.g., syringe). In addition to a syringe port coupled to the piston pump 18, the distribution valve 88 may include, for example, 2, 3, or more ports for fluid connection to components of the generator system 10 (e.g., emanation chamber 14 and collection container 16, as explained herein). The distribution valve 88 enables the piston pump 18 to fluidly connect to one and only one of the ports at a time, as explained below. In this example, the distribution valve 88 functions as the inlet and outlet valves 70, 80, as can be understood from the below description. In such an example, the generator system 10 may include one or both of an inlet check valve 70a or an outlet check valve 80a, as explained below. In other examples, one or both of the check valves 70a, 70b may be omitted.

As can be seen in FIG. 9B, for example, each illustrated distribution valve 88 includes a body 89 defining first, second, and third distribution ports 90a, 90b, 90c, respectively, and a piston pump port 90d. In the illustrated embodiment in FIG. 9B, the third distribution port 90c is shown as an optional port. Inside the body 89 is a plug (e.g., rotor) 91 that is selectively movable (e.g., rotatable) to define fluid flow paths within the distribution valve 88. The plug 91 is operatively connected to a valve actuator 92 (e.g., rotary actuator) of the generator 12, which is in turn controlled by the controller 54 to enable selective flow paths during operation, as explained below. The valve 88 may comprise polychlorotrifluoroethylene or other inert polymer or material.

FIGS. 9C-9E illustrate simplified schematic representations of the generator system 10, including the rotational positions of the plug 91 to enable selective flow paths. These figures illustrated only a single distribution valve 88 and piston pump 18 for ease of illustration. In these examples, the first port 90a is fluidly coupled to the emanation chamber 14 via a fitting secured (e.g., threadably secured) to the port and tubing 72 connected to the fitting. The inlet check valve 70a is disposed upstream of the first portion 90a of the distribution valve 88. The second port 90b is fluidly coupled to the collection container 16 via a fitting secured (e.g., threadably secured) to the port and tubing 82 connected to the fitting. The outlet check valve 80a is disposed downstream of the second port 90b of the distribution valve 88. In this example, the third port 90c may be omitted, or not fluidly coupled to a component of the generator system 10, but may enable venting to atmosphere or may be coupled to a component, such as described below, or may be fluidly coupled to a component of the generator as explained below.

FIG. 9C illustrates the distribution valve 88 in an emanation-drawing configuration, in which the first port 90a is open and in fluid communication with the piston pump port 90d, and the second and third ports 90b, 90c are closed and not in fluid communication with the piston pump port. The controller 54 may be programmed to operate the valve actuator 92 to rotate the plug 91 of the distribution valve 88 to the emanation-drawing configuration to open the first port 90a enable fluid communication between the emanation chamber 14 and the piston pump 18, whereby isotope from the emanation chamber is drawn into the piston pump by actuating the pump actuator 66, such as through use of the controller. The inlet check valve 70a enables the flow of isotope into the distribution valve 88 and inhibits back flow. The inlet check valve 70 may be omitted in one or more embodiments.

FIG. 9E illustrates the distribution valve 88 in an isotope-evacuating configuration, in which the second port 90b is open and in fluid communication with the piston pump port 90d, and the first and third ports 90a, 90c are closed and not in fluid communication with the piston pump port. The controller 54 may be programmed to operate the valve actuator 92 to rotate the plug 91 of the distribution valve 88 to the isotope-evacuating configuration to enable fluid communication between the piston pump 18 and the collection container 16, whereby isotope from the piston pump is dispensed through the second port 90b by actuating the pump actuator 66, such as through use of the controller. The outlet check valve 80a enables the flow of isotope out of the distribution valve 88 and inhibits back flow. The outlet check valve 80a may be omitted in one or more embodiments.

FIG. 9D illustrates another embodiment that further includes a solvent source 93 such as an acid, including but not limited to HCl (e.g., 0.1N HCl), is fluidly connected to the third port 89c. As an example, the solvent source 93 may include a syringe directly connected (e.g., threaded) into the third port 89c. In another example, the solvent source 93 may be a container and tubing with a fitting may be connected to the third port 89c. An inlet check valve 94 may be provided to inhibit backflow of solvent. The purpose of the solvent source 93 is explained below.

In FIG. 9D, the distribution valve 88 in an solvent-drawing configuration, in which the third port 90c is open and in fluid communication with the piston pump port 90d, and the first and second ports 90a, 90b are closed and not in fluid communication with the piston pump port. The controller 54 may be programmed to operate the valve actuator 92 to rotate the plug 91 of the distribution valve 88 to the solvent-drawing configuration to enable fluid communication between the piston pump 18 and the solvent source 93, whereby solvent from the solvent source is drawn through the third port 90c by actuating the pump actuator 66, such as through use of the controller. Another inlet check valve may be disposed between the solvent source 93 and the distribution valve 88 enables the flow of solvent into the distribution valve and inhibits back flow. The inlet check valve may be omitted in one or more embodiments.

In one example, the collection container 16 comprises a serum vial (5 cc, 10 cc or 20 cc) or appropriate flask, containing, for example, 2-3 mL of a solvent (e.g. dilute HCl). At the end of the operation of the generator 12, the collection container may include the final product (i.e., solution) to be delivered to or received by the radiochemist, radio pharmacist, and/or researcher for compounding.

In one embodiment, the solvent S from the collection container 16 may be drawn into the piston pump 18, rather than having a separate solvent source, such as source 93. In such an example, the distribution valve 88 would be in the isotope-evacuating configuration shown in FIG. 9E, but instead of dispensing isotope from the piston pump 18, the piston pump is actuated to draw the solvent S from the collection container 16 into the piston pump. As an example, the collection container 16 may include a greater amount of solvent (e.g. dilute HCl) than the prior embodiment, such as 10 mL. Exemplary operations using this embodiment below in Example 2: Operation for Producing Lead-212 and Example 2: Operation for Rinsing Lead-212 Generator.

### Example 1: Operation for Producing Lead-212

An exemplary Lead-212 generator and an automated method for producing Lead-212 using the Lead-212 generator will now be described with reference to the above description and the figures.

In this example, the starting or parent isotope 32 is solid Radium-224. Radium-224 is applied to the substrate 30, such as by chemical deposition, to form a Radium-224 coupon 22. This coupon 22 is received in the interior cavity 20 defined by the emanation chamber 14. Radium-224 has a half-life 3.6319 days and decays to the Radon-220 gas which has a half-life of 55.6 seconds. Radon-220 gas decays to Polonium-216 (half-life 0.145 seconds) which decays to Lead-212. Polonium-216 can be disregarded due to its extremely short half-life, and only the decay process of Radon-220 to Lead-212 is considered. Like Radium, Lead has a +2 charge upon decay from Radon-220, thus Lead-220 will firmly bind to the substrate 30, same as Ra2+, if not displaced immediately from the vicinity of the substrate.

In general, using the disclosed isotope generator 12 including first and second piston pumps 18 and the distribution valves 88, the active airflow through the emanation chamber 14 entrains the Radon-220 gas (created from the decay of Radium-224) and moves it from the emanation chamber into the decay chamber 60 (i.e., barrel of piston pump). The combination of the appropriate substrate 30 which permanently or firmly binds Radium-224, and active airflow which displaces Radon-220 gas, enables isolation of Lead-212 away from the Radium-224 source, thereby leading to radionuclidically pure Lead-212. Moreover, chemically inert components of the generator in which the isotopes contact (e.g., tubing, chamber, container, pump components) facilitates a radiochemically pure Lead-212 product as well. Moreover still, as explained below, the offset timing of the operations of the two piston pumps 18 and distribution valves 88 enables constant airflow through the emanation chamber 14 and efficient Lead-212 production.

The emanation chamber 14—including the Radium-224 coupon 22 disposed therein—is loaded into the generator 12 so that the inlet emanation flow channel(s) 26 is in fluid communication with ambient air (and the drying agent 40 and air filter 42), and the outlet emanation flow channel(s) 28 is in fluid communication with the inlet check valve 70. The user selects a “run” program of the generator 12. For example, as shown schematically in FIG. 8, the generator 12 may include a user interface 90 in communication with the controller 54 and enabling the user to select the “run” or operate program. The run program is stored in the memory 58 and is accessible by the processor 56 of the controller 54. These instructions instruct the controller 54 to automatically operate the generator 12, and more particularly, cycle the respective first and second piston pumps 18 through a sequence of operations, including draw operations, hold operations, and evacuation operations. As explained above, the controller 54 may control the actuators 66 associated with the piston pumps 18 to control operations of the pumps, embodiments of which are described below

In one example, before beginning the generation operation, one or both of the piston pumps 18 may draw the solvent (e.g., 2-3 mL) into the pumps from the solvent source 93. In such an example, the distribution valve 88 may be in the solvent-drawing configuration, such as shown in FIG. 9D. In other examples, the piston pumps 18 may be empty or preloaded with solvent. In another embodiment described in Example 2, the solvent is drawn from the collection container 16.

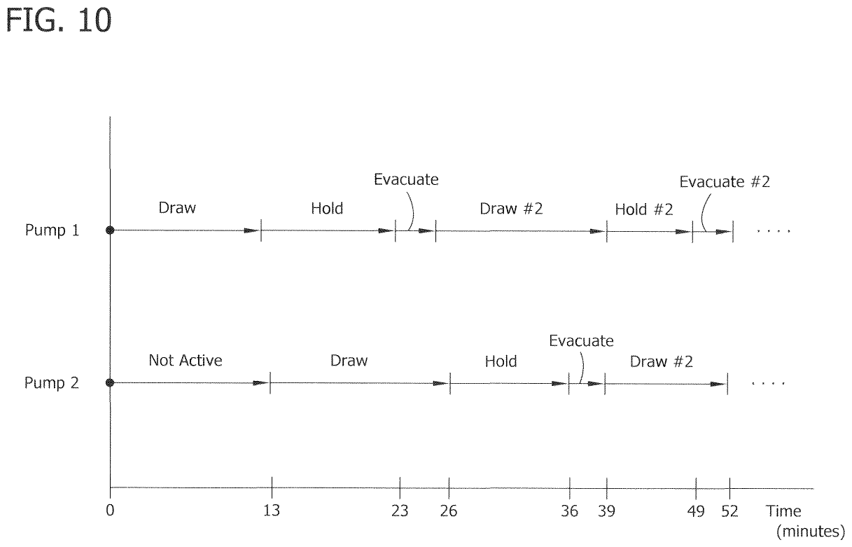

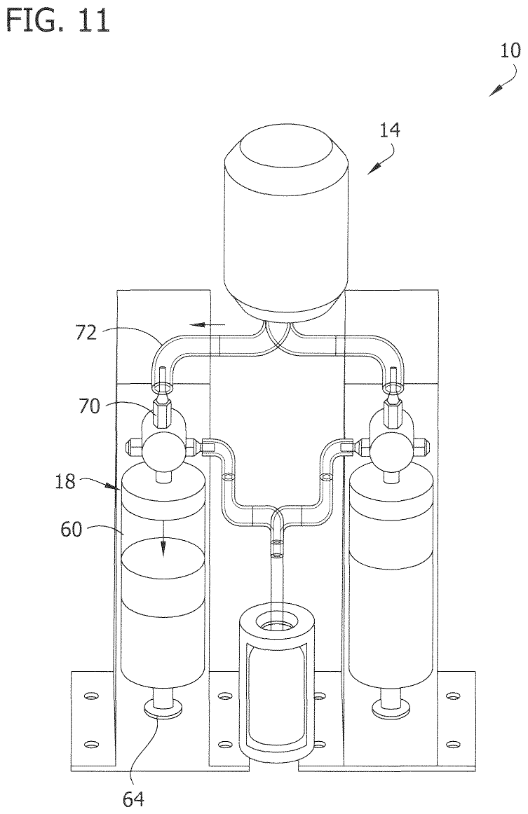

Referring to FIGS. 10 and 11, the first operation is a DRAW operation using one of the piston pumps 18 (a first piston pump), and a NOT ACTIVE operation of the second pump 18. The first distribution valve 88 is in the emanation-drawing configuration (e.g., FIG. 9C), such as by the controller 54 operating the actuator 92 to rotate the plug 91 to a selected rotational position. The controller 54, using the piston actuator 66, actuates continuous, linear movement of the piston 64 of the first piston pump 18 away from the head of the barrel 60. This continuous linear movement creates negative pressure, which draws ambient air through the drying agent 40 and the air filter 42 and into the emanation chamber 14 to create a continuous, positive air flow across the Radium-224 coupon 22. Emanated Radon-220 gas from the Radium-224 coupon is entrained in the air flow and moved through the first inlet conduit 72, the first inlet check valve 70 (when present), the distribution valve 88 and into the first decay chamber 60. In one example, the first piston 64 is continuously pulled at a rate such that after about 13 minutes (or in another example, about 8 minutes), the piston is stopped at an end position so that first piston pump 18 is at the end of the DRAW operation. During the DRAW operation of the first piston pump 18, the second piston pump 18 is not active.

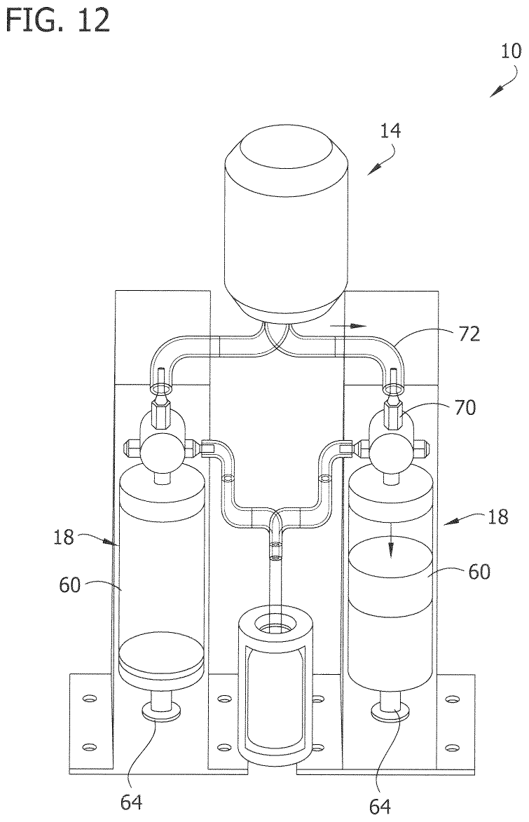

Referring to FIGS. 10 and 12, upon completion of the DRAW operation of the first piston pump 18, the controller 54 initiates a HOLD operation of the first piston pump 18 and a DRAW operation of the second piston pump. The first piston 64 is held at its end position for a selected amount of time to enable the daughter isotope(s) in the decay chamber 60 to more fully or substantially decay into Lead-212. In one example, the first distribution valve 88 may remain in the emanation-drawing configuration and the first inlet check valve 70 inhibits isotope in the first piston pump 18 from flowing back toward the emanation chamber 14 and inhibits the isotope from the emanation chamber from flowing into the first piston pump. In addition or alternatively, the first distribution valve 88 may be actuated, such as by the controller 54, so that none of the ports 90a, 90b, 90c are in communication with the piston pump port 90d. As an example, the hold cycle may be about 10 minutes, which is about 10 half-lives of Radon-220.

The DRAW operation of the second piston pump 18 may be the same as the draw cycle of the first piston pump. Thus, the second distribution valve 88 is in the emanation-drawing configuration, such as by the controller 54 operating the actuator 92 to rotate the plug 93 to a selected rotational position, and the second piston pump 18 is drawing isotope into the decay chamber 60 during the HOLD operation of the first piston pump. The controller 54 actuates continuous, linear movement of the piston 64 of the second piston pump 18 away from the head of the second barrel 60. This continuous linear movement creates negative pressure, which draws ambient air through the drying agent 40 and the air filter 42 and into the emanation chamber 14 to create a continuous, positive air flow across the Radium-224 coupon 22. Emanated Radon-220 gas is entrained in the air flow and moved through the second inlet conduit 72 and the second inlet valve 70 into the second decay chamber 60. In one example, the second piston 64 is continuously pulled at a rate such that after about 13 minutes (or in another example, about 7.5 minutes), the second piston pump 18 is stopped at an end position so that second piston pump is at the end of the DRAW operation.

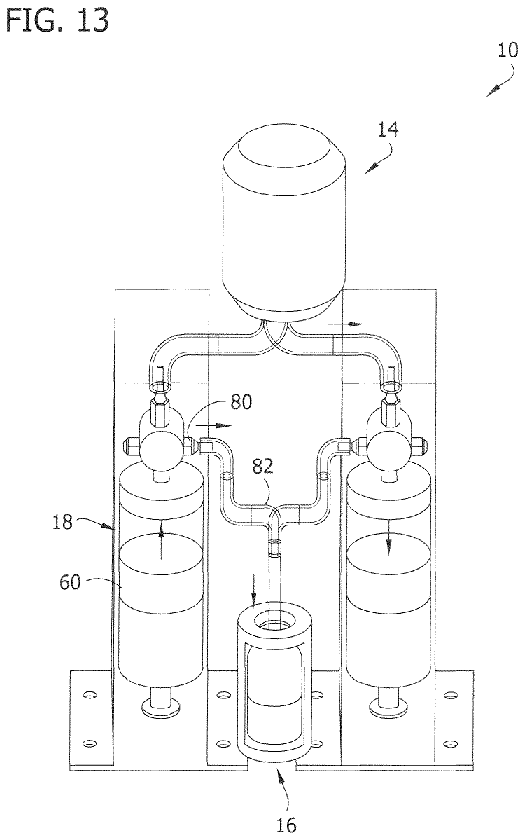

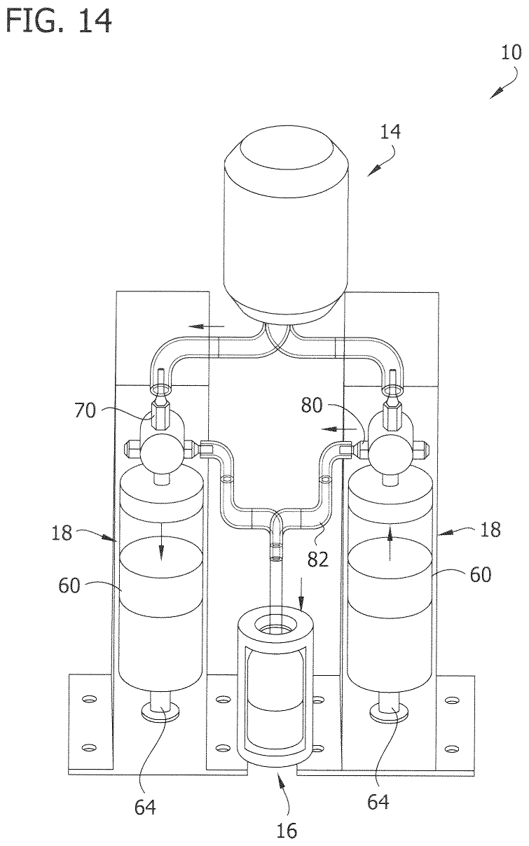

Referring to FIGS. 10 and 13, at the end of the HOLD operation of the first piston pump 18, the controller 54 initiates an EVACUATION operation of the first piston pump. In one example, the distribution valve 88 is configured in the isotope-evacuating configuration (e.g., FIG. 9E), such as by the controller 54 operating the valve actuator 93 to rotate the plug 91 to a selected rotational position. During this operation, the controller 54 actuates continuous, linear movement of the piston 66 of the first piston pump 18 toward the head of the first barrel 60. This linear movement creates positive pressure, which forces the Lead-212 in the decay chamber through the second port 90b, the outlet check valve 80 (when present), the outlet conduit 82, and into the collection container 16. Lead-212 is captured in the collection chamber 16 by the solvent S (e.g., dilute HCl) or other material. The EVACUATION operation may last 3 minutes. The DRAW operation of the second piston pump 18 is still occurring during the EVACUATION operation of the first piston pump 18.

Referring to FIG. 10, the end of the EVACUATION operation of the first piston pump 18 and the end of the DRAWING operation of the second piston pump may occur substantially simultaneously. At this time, the controller 54 initiates a HOLD operation of the second piston pump 18. The controller 54 also initiates a second cycle of the DRAW, HOLD, and EVACUATION operations of the first piston pump 18. In one example, during the HOLD operation the second distribution valve 88 may remain in the emanation-drawing configuration and the check valve 70 inhibits isotope in the second piston pump 18 from flowing back toward the emanation chamber 14 and inhibits the isotope from the emanation chamber from flowing into the first piston pump. In addition or alternatively, the second distribution valve 88 may be actuated, such as by the controller, so that none of the ports are in communication with the pump port.

At the end of the HOLD operation of the second piston pump 18 (e.g., 10 minutes), the controller 54 initiates an EVACUATION operation of the second piston pump (e.g., about 1-3 minutes). In one example, the second distribution valve 88 is configured in the isotope-evacuating configuration (e.g., FIG. 9E), such as by the controller 54 operating the valve actuator 93 to rotate the plug 91 to a selected rotational position. As shown in FIG. 14, the first piston pump 18 continues its second DRAW operation during the EVACUATION operation of the second piston pump 18. The EVACUATION operation of the second piston pump 18 and the second DRAW operation of the first piston pump 18 end substantially simultaneously. At the end of the EVACUATION operation of the second piston pump 18, the controller initiates a second cycle of the DRAW, HOLD, and EVACUATION operations of the second piston pump. The controller 54 may be programmed to run a selected number of the cycles of the first and second piston pumps 18.

As can be seen from the above disclosure and FIG. 10, the timing of the operations of the first and second piston pumps 18 enables continuous airflow through the emanation chamber 14. Thus, there is continuous capture of Radon-220 gas in the air flow and delivery to one of the decay chambers 60 to enable subsequent decay into Lead-212. The controller 54 may include a program to run a selected number of cycles based on the amount of Radium-224 present in the emanation chamber.

### Example 2: Operation for Rinsing Lead-212 Generator

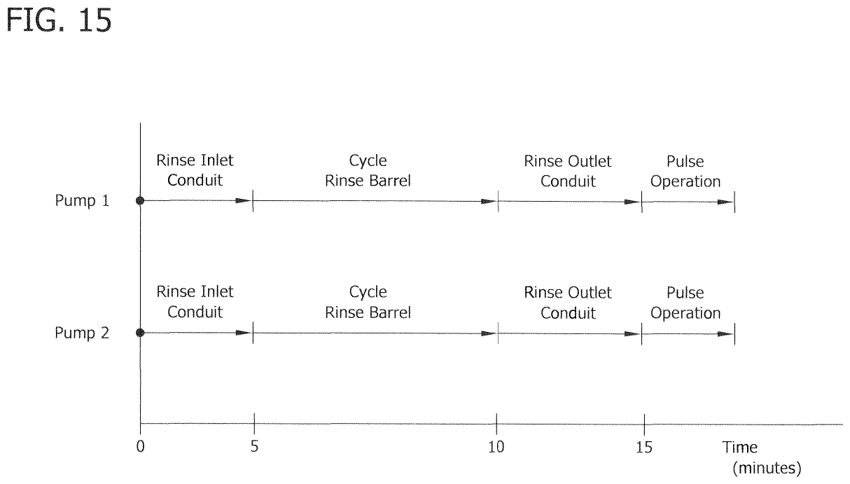

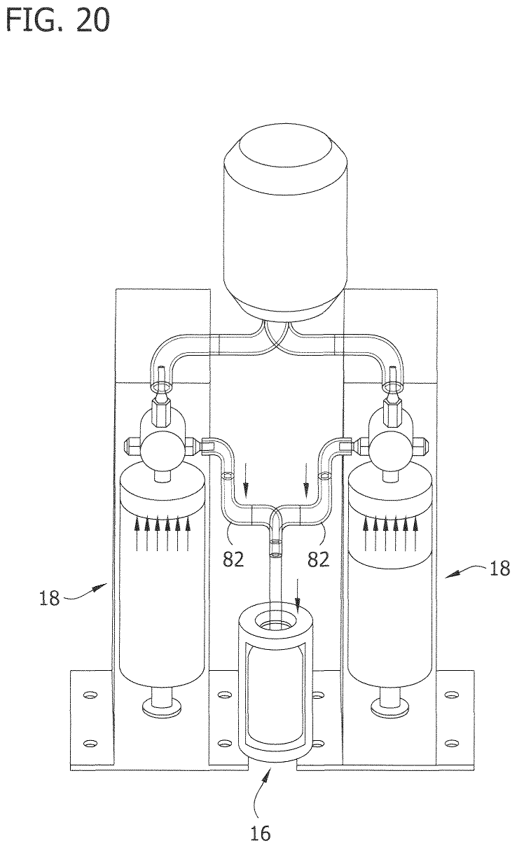

Referring to FIGS. 15-20, an exemplary operation of an automated program for rinsing components of the generator 12 to evacuate any residual Lead-212 from the generator will now be described.

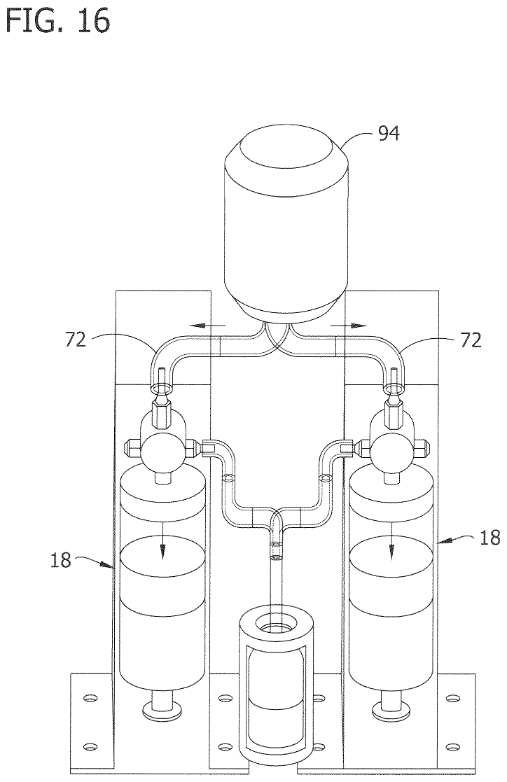

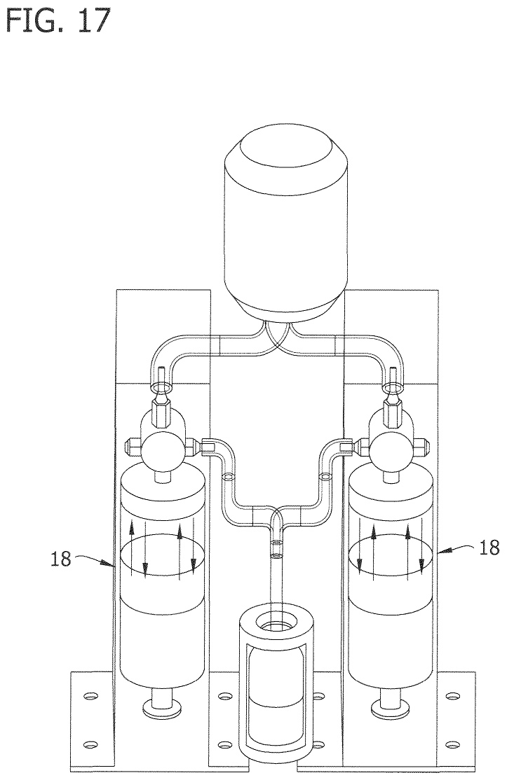

In one example, shown in FIG. 16, after completion of the above Lead-212 operation of the generator 12, the emanation chamber 14 is removed from the generator and replaced with a rinse chamber 94. The rinse chamber 94 contains a solvent, such as an acid, including but not limited to HCl (e.g., 0.1N HCl). The rinse chamber 94 may contain 2-4 mL of the solvent. In another example, the emanation chamber is not removed. Instead, the solvent container(s) 93 (FIG. 9D) is used to rinse the generator 12.

The user interface 90 may enable the user to select a “rinse” program. The rinse program stored in the memory 58 accessible by the processor 56 of the controller 54. These instructions instruct the controller 54 to automatically rinse the generator 10, and more particularly, cycle the respective first and second piston pumps 18 through a sequence of operations. As explained above, the controller 54 may control actuators 66 associated with the piston pumps 18 to control operations of the pumps. The sequences of operations controlled by the controller 54 are described below.

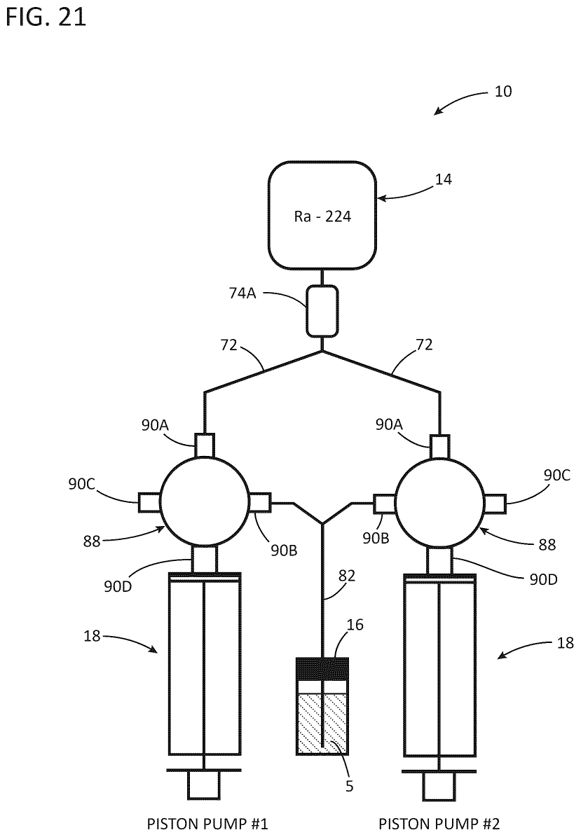

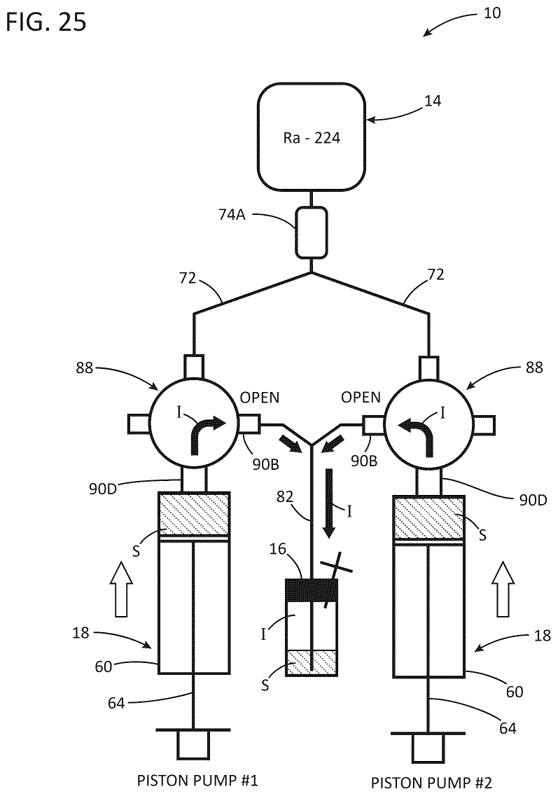

Referring to FIGS. 15 and 16, during a RINSE INLET CONDUIT operation, the controller 54 actuates the piston pumps 18 simultaneously to draw the 0.1N HCl solution into the inlet conduits, filling the full volume of the inlet conduits 72. The piston pumps are stopped for a hold period (e.g., 5 min) to enable greater solubility of any Lead-212 adsorbed into the walls of the inlet conduits. In another example where the solvent container 93 is used, the first and second distribution valves 88 may be in the solvent-drawing configuration shown in FIG. 9D, to enable solvent to be drawn into the piston pumps 18. In such an example, the Y-port 74 shown in FIG. 9A may be a check valve or the generator 10 may otherwise include a check valve, such as check valve 74a shown in FIGS. 21-32, that inhibits fluid flow into the emanation chamber 14. In this case, after drawing solvent into one or both of the pumps 18, the pumps may alternate between drawing and dispensing the solvent so that the solvent flows through the inlet conduits 72. It is envisioned that in such an embodiment the check valve 70 may be omitted and/or replaced with a suitable valve. A similar step is described in Example 3, below.

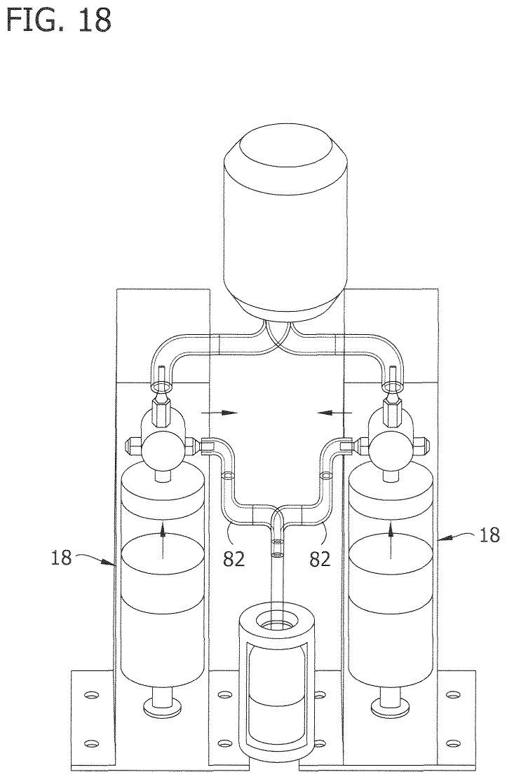

Referring to FIG. 15, after the RINSE INLET CONDUIT operation, the controller initiates a RINSE BARREL operation. During this operation, the piston pumps 18 are operated to pull the remaining HCl solution through the inlet conduits 72 and into the decay chambers 60. Referring to FIG. 17, the pistons reciprocate within the decay chambers 60 (i.e., barrels) to move the volume of HCl solution between ends of the decay chambers. As an example, where the barrels 60 are 50 mL, the pistons 64 move back and forth from about the 3 mL mark to the 47 mL mark of the barrels. This cycle is repeated (e.g., 5 times) to maximize solubility of any Lead-212 adsorbed onto the barrel walls. In one example, each cycle (3 mL to 47 mL to 3 mL) lasts 2 min, for a total of 10 mins of barrel rinse.

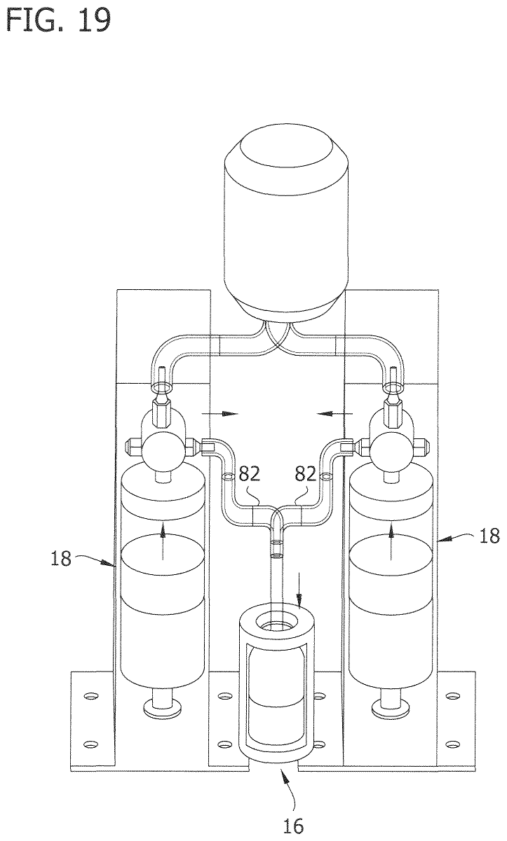

At the end of the RINSE BARREL operation, the program may pause, waiting for the user to select continue sequence. After is the user selects to continue, the controller 54 initiates a RINSE OUTLET CONDUIT operation, as shown in FIGS. 15 and 18. The controller 54 moves the pistons 64 to the heads of the barrels 60 (e.g., 0 mL position), evacuating the 0.1N HCl solution in each barrel into the outlet conduits 82. With the outlet conduits 82 filled with 0.1N HCl, the program halts piston movement for a period of time (e.g., 5 min). As shown in FIG. 19, the controller 54 then actuates the piston pumps 18 to withdraw the pistons 64 to the 5 mL mark, drawing in ambient air, and then move the pistons to the heads of the barrels 60 to push the 0.1N HCl contained in the outlet conduits 82 into the collection container 16.

Finally, to retrieve any residual solution on the pistons 64 (e.g., piston seals), the controller 54 initiates a PULSE operation. The pistons 64 are positioned at the 0 mL position, and the pistons are actuated to further move the pistons toward the barrel heads. The excess force of the pulse applies excess upward pressure which forces residual liquid residing on the piston seal through the outlet conduits 82 and into the collection container 16.

### Example 3: Operation for Producing Lead-212

Referring to FIGS. 21-23, another operation for producing Lead-212 using the generator system 10 is shown schematically. The generator system 10 is substantially the same as the generator system described above, with the main difference being its operation controlled by the controller 54, meaning the controller is programmed to operate differently, as described below. Because the generator systems 10 are substantially identical, like components are indicated by corresponding reference numerals. As described above, the system may or may not include the inlet and outlet check valves 70a, 80a, which are not illustrated in this embodiment. In this embodiment, however, the system 10 include an inlet check valve 74a downstream of the emanation chamber and upstream of the y-port where the inlet conduits split to the two distribution valve 88 and piston pumps 18.

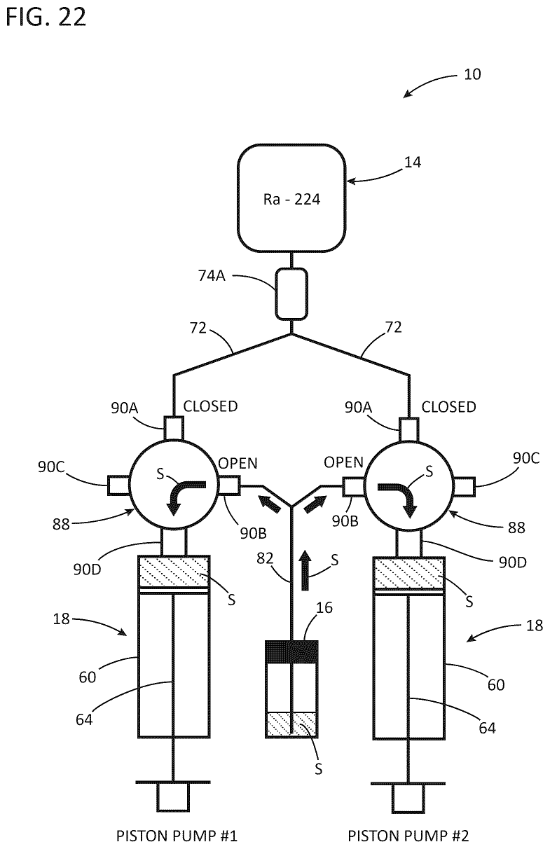

Referring to FIG. 21, at the initial set up before beginning the isotope generation process, the emanation chamber 14 that includes the parent isotope (e.g., coupon 22, such as Ra-224) is loaded in the generator 12, and a suitable volume of solvent S (e.g., 10 ml) is received in the collection container 16. The piston pumps 18 are at their initial positions. Referring to FIG. 22, the second ports 90b of the first and second piston pumps 18 are open, such as by the controller 54 operation the valve actuator 92 so that the collection container 16 is in fluid communication with the piston pumps 18. The piston pumps 18 are operated, such as by the controller 54 operating the piston actuators 66, to draw a selective volume of solvent S into the barrels 60 of the pumps. In one example, 3 ml of solvent is drawn into each of the pumps, leaving about 4 ml of solvent in the collection container 16.

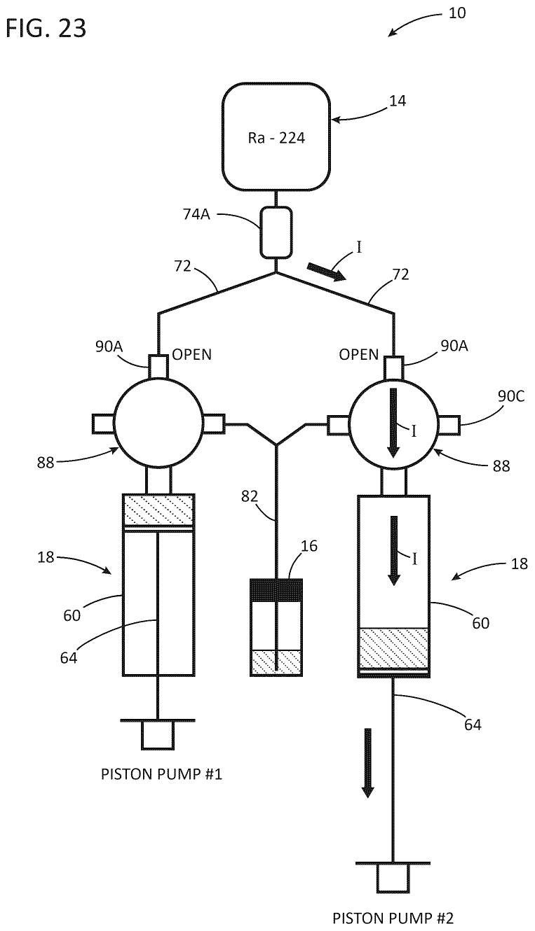

The isotope generation process is initiated after the piston pumps 18 include a selected volume of solvent. The operation may be substantially similar to Example 1, but with different timing operations, as described above. Thus, operation and timing sequences of the two pumps alternate and overlap, as with Example 1. The below is a brief description of the operation shown in FIGS. 23-25.

One or both of the distribution valves 88 are configured in the emanation-drawings configuration (e.g., FIG. 9C). For example, the controller 54 operates one or both of the actuators 93 to rotate the plug 91 so that the first port(s) 90a is open, whereby the emanation chamber 14 is in fluid communication with at least one of the piston pumps 18. The controller 54 operates one of the piston pumps 18 (e.g., the second or right piston pump, as illustrated) to draw isotope I (e.g., Rn-220) into the decaying chamber 60. As an example, the pump may draw continuously for a selected amount of time, such as about 8.6 minutes. The pump is held for a selected time, such as 7.5 minutes, to enable decay into the desired isotope (e.g., Lead-212) and its daughter isotope. Because of the presence of the solvent in the decay chamber 60, at least some of the desired isotope and its daughter isotope may dissolve in the solvent during the hold period to form an isotope solution. At least some of the desired isotope may still be in the entrained gas in the decay chamber. During the hold time, the desired isotope (and its daughters) may be present in both the entrained gas and the solvent (forming a solution). Moreover, the desired isotope (and its daughter) may also be present on the interior surface of the decay chamber, which may be released from the surface and dissolved in the solvent S during the rinsing operation. After the hold period, the controller 54 operates the pump (e.g., pump 2) to evacuate the gas (e.g., 47 mL) from the barrel 60, while leaving the solvent (or solution) in the pump. The pump may be operated for about 1.1 min during evacuation.

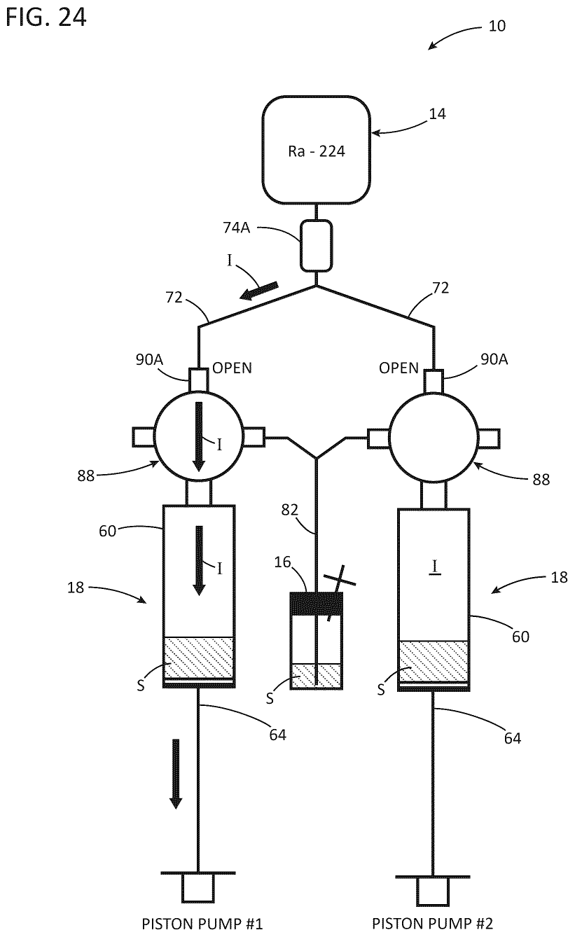

Referring to FIG. 24, at the start of the hold period of the pump (e.g., pump 2), the controller 54 operates the other of the piston pumps 18 (e.g., the first or left piston pump, as illustrated) to draw isotope I (e.g., Rn-220) into the decaying chamber 60. The draw, hold, and evacuate timing is the same as the other pump. So, the isotope is drawn for a selected time, such as about 8.6 minutes, and held for a selected time, such as about 7.5 min, to enable decay into the desired isotope (e.g., Lead-212), and then the chamber is evacuated for a selected time, e.g., about 1.1 min, while leaving the solvent (or solution) in the chamber.

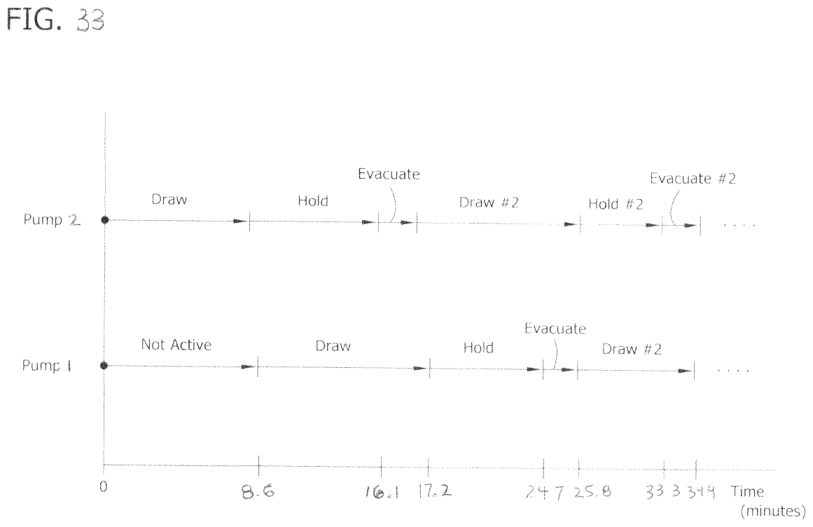

An example of a timing sequence for the controller 54 executing this generation process is shown in FIG. 33.

### Example 4: Operation for Rinsing Lead-212 Generator

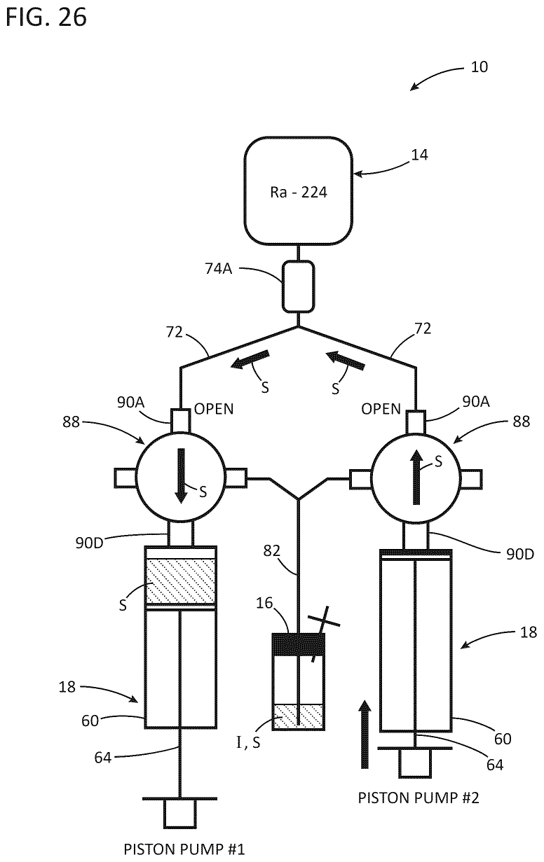

After the isotope generation process, such as explained in Example 3, the rinsing operation is initiated. At the beginning of the rinsing operation, the positions of the pumps 18 are as shown in FIG. 24, such that each of the pumps includes isotope solution (e.g., each includes 3 mL of isotope solution). The first ports 90a of both valves 88 are open. As shown in FIG. 26, the second pump 18 is operated to move the piston to the head of the barrel, thereby emptying the second barrel and moving the isotope solution toward the first pump. Simultaneously, the piston of the first pump is moved to a selected position, e.g., 7 mL mark. At the end of these operations, as shown in FIG. 26, the first pump contains all of the isotope solution (e.g., 6 mL).

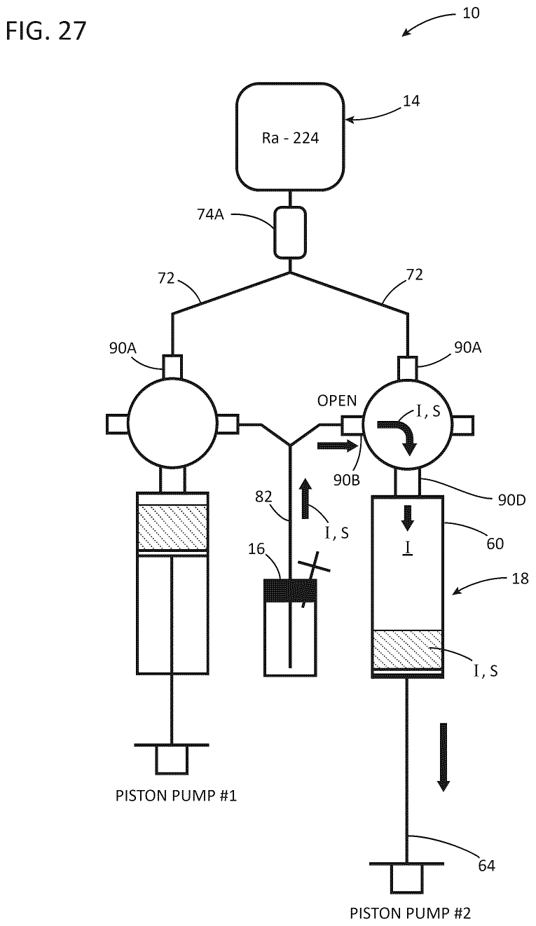

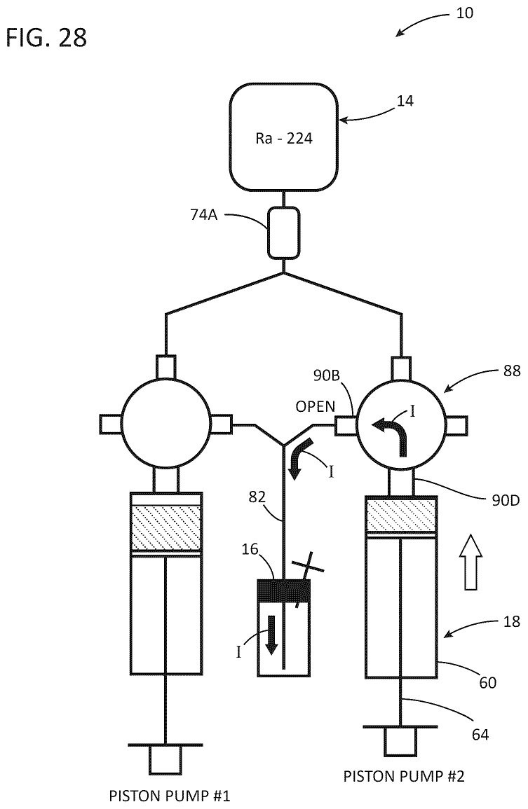

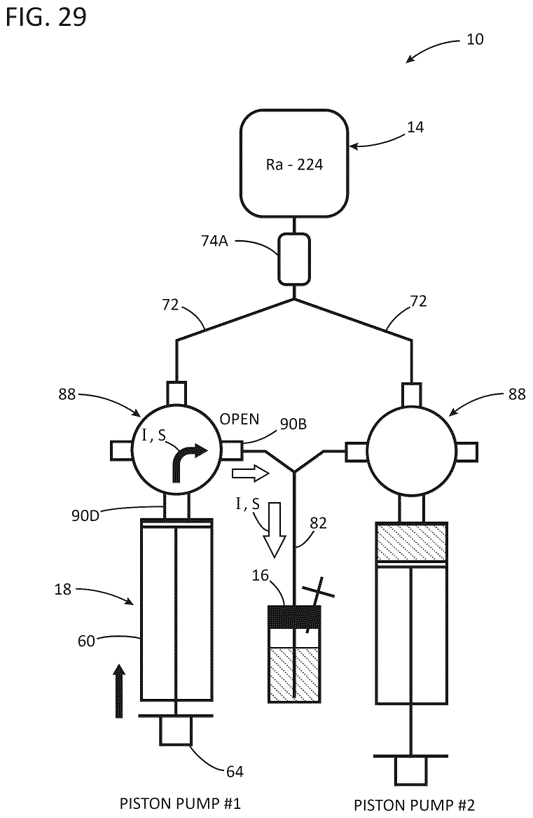

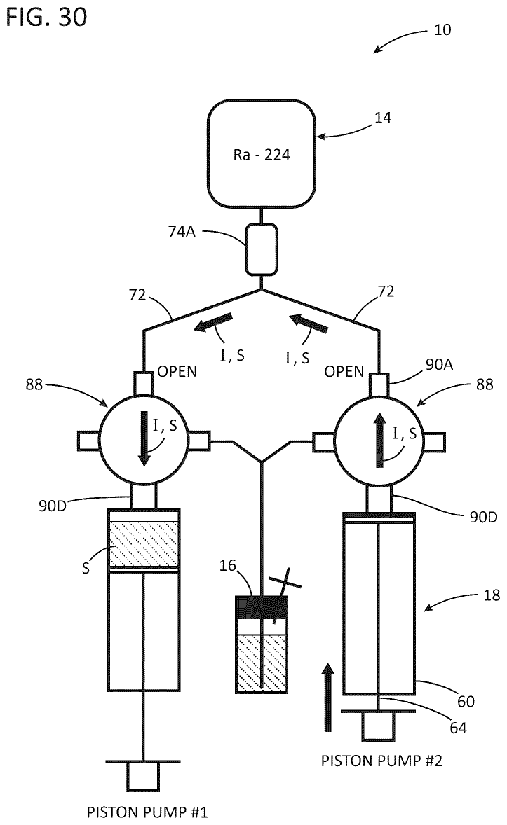

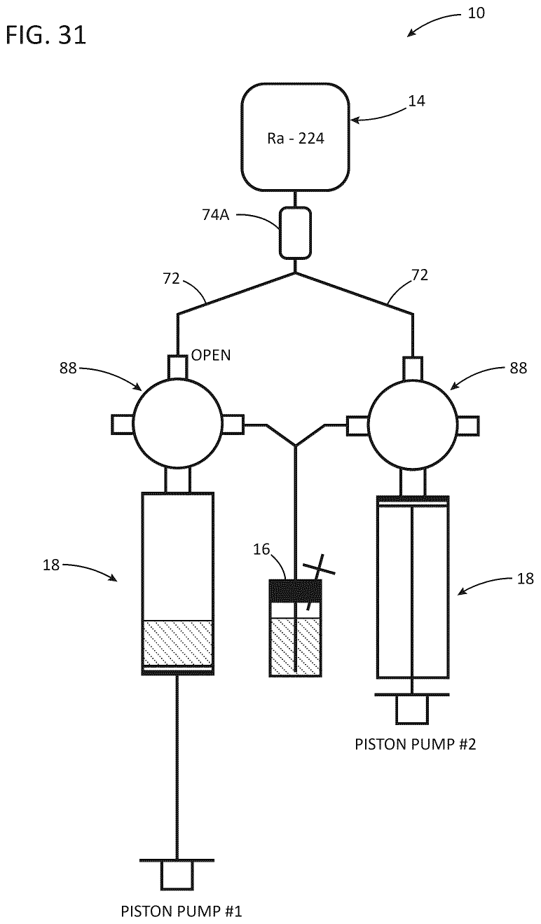

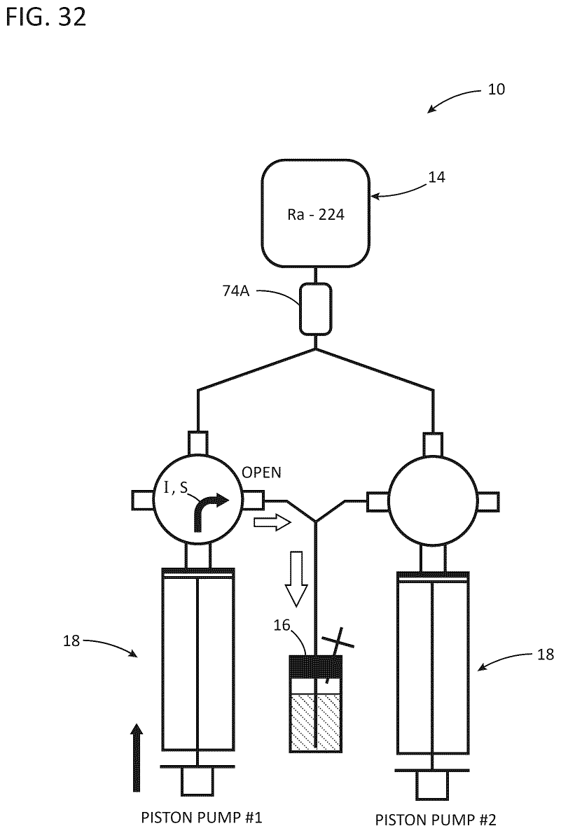

As shown in FIG. 27, the first port 90a associated with the empty pump 18 (e.g., second pump) is open and the pump is operated to draw the solvent/solution from the collection container 16 into the pump. As shown in FIG. 28, the isotope entrained in the gas is evacuated from the pump and delivered to the collection chamber 16, leaving the isotope solution in the pump. As shown in FIG. 29, the solvent (or solution) is evacuated from the other pump (e.g., the first pump) and delivered to the collection container 16. In FIG. 30, the solution in the second pump 18 is delivered through the first conduit 72 to the first pump. Finally, in FIGS. 31 and 32, the solution is delivered from the first pump 18 to the collection container 16, which contains 10 ml, for example, of the isotope solution.

### Exemplary Embodiments

At least some embodiments of the invention may be further described by reference to the following numbered paragraphs:
1. An isotope generator system for producing Pb-212 for Targeted Alpha Therapy (TAT) from a parent isotope, the isotope generator system comprising:
   an emanation chamber configured to hold the parent isotope therein;
   an isotope collection container; and
   an isotope generator including at least one fluid mover and at least one decay chamber, each in selective fluid communication with the emanation chamber and the isotope collection chamber,
   wherein the at least one fluid mover is configured to selectively generate gas flow from the emanation chamber to the at least one decay chamber, whereby a gaseous daughter intermediary isotope from the parent isotope in the emanation chamber is entrained in the gas flow and delivered into the decay chamber,
   wherein the at least one decay chamber is configured to retain a gaseous intermediary daughter isotope therein to enable decay of the gaseous intermediary daughter isotope to Pb-212 and its daughter isotope,
   wherein the at least one fluid mover is configured to selectively generate fluid flow from the at least one decay chamber to the isotope collection chamber to deliver the Pb-212 and its daughter isotope in the decay chamber into the isotope collection chamber.
2. The isotope generator system of paragraph 1, wherein the at least one fluid mover and the at least one decay chamber comprise a piston pump including a reciprocating piston received in a barrel, the barrel functioning as the decay chamber.
3. The isotope generator system of paragraph 2, wherein the isotope generator includes a piston actuator configured to drive linear, reciprocating movement of the piston within the barrel.
4. The isotope generator system of any one of paragraphs 1-3, wherein the isotope generator includes a plurality of fluid movers and a plurality of decay chambers.
5. The isotope generator system of any one of paragraphs 1-4, wherein the isotope generator includes a controller configured to control operation of the plurality of fluid movers to cycle through draw operations, hold operations, and evacuation operations.
6. The isotope generator system of paragraph 5, wherein the controller is configured to offset timing of operations of the plurality of fluid movers to enable continuous gas flow through the emanation chamber.
7. The isotope generator system of any one of paragraphs 1-6, further comprising distribution valve including an inlet port to selectively fluidly connect the emanation chamber and the at least one decay chamber, and an outlet port to selectively fluidly connect the at least one decay chamber and the isotope collection chamber.
8. The isotope generator system of paragraph 7, further comprising:
   inlet check valve downstream of the emanation chamber to inhibit backflow of isotope through the inlet port; and
   an outlet check valve downstream of the decay chamber to inhibit backflow of isotope through the outlet port.
9. The isotope generator system of any one of paragraphs 1-8, wherein the emanation chamber includes a parent isotope coupon comprising a substrate and the parent isotope disposed on at least one surface of the substrate.
10. The isotope generator system of paragraph 9, wherein the substrate includes an oxide layer on which the parent isotope is disposed to inhibit absorption of the parent isotope and the gaseous intermediary daughter isotope in the substrate.
11. The isotope generator system of any one of paragraphs 1-10, wherein the parent isotope comprises Radium-224, and the gaseous intermediary daughter isotope comprises Radon-220.
12. An isotope generator for producing an isotope for Targeted Alpha Therapy (TAT) from a parent isotope, the generator comprising:
   at least one fluid mover configured to be in selective fluid communication with an emanation chamber holding the parent isotope therein; and
   at least one decay chamber in selective fluid communication with the emanation chamber,
   wherein the at least one fluid mover is configured to selectively generate gas flow from the emanation chamber to the at least one decay chamber, whereby a gaseous daughter isotope from the parent isotope in the emanation chamber is entrained in the gas flow and delivered into the at least one decay chamber,
   wherein the at least one decay chamber is configured to retain a gaseous intermediary daughter isotope therein to enable decay of the gaseous intermediary daughter isotope to the isotope for TAT and its daughter isotope,
   wherein the at least one fluid mover is configured to selectively generate fluid flow so that the isotope for TAT and its daughter isotope in the at least one decay chamber is evacuated from the at least one decay chamber.
13. The isotope generator of paragraph 12, wherein the at least one fluid mover and the at least one decay chamber comprise a piston pump including a reciprocating piston received in a barrel, the barrel functioning as the decay chamber.
14. The isotope generator of any one of paragraphs 12 or 13, further comprising a controller configured to control operation of the at least one fluid mover to cycle through draw operations, hold operations, and evacuation operations.
15. The isotope generator of any one of paragraphs 12-14, further comprising a distribution valve including an inlet port to selectively fluidly connect the emanation chamber and the at least one decay chamber, and an outlet port to selectively fluidly connect the at least one decay chamber to enable evacuation of the isotope for TAT and its daughter isotope from the at least one decay chamber.
16. The isotope generator of any one of paragraphs 12-15, wherein the at least one fluid mover comprises a plurality of fluid movers and the at least one decay chamber comprises a plurality of decay chambers.
17. A method for producing Pb-212 for Targeted Alpha Therapy (TAT) from a parent isotope, the method comprising:
   selectively generating gas flow, using at least one fluid mover, from an emanation chamber holding the parent isotope to at least one decay chamber so that a gaseous intermediary daughter isotope emanating from the parent isotope in the emanation chamber is entrained in the gas flow and delivered into the at least one decay chamber;
   retaining the gaseous daughter isotope within the at least one decay chamber for a selective amount of time so that the gaseous daughter isotope decays to Pb-212 and its daughter isotope; and
   selectively generating fluid flow, using the at least one fluid mover, from the at least one decay chamber to an isotope collection chamber so that Pb-212 and its daughter isotope in the decay chamber is evacuated from the at least one decay chamber.
18. The method of paragraph 17, wherein selectively generating gas flow from the emanation chamber to the at least one decay chamber comprises actuating a piston pump to create negative pressure that draws gas through the emanation chamber.
19. The method of any one of paragraphs 17 or 18, wherein selectively generating gas flow from the at least one decay chamber to evacuate the Pb-212 and its daughter isotope from the at least one decay chamber comprises actuating a piston pump to create positive pressure that evacuates the at least one decay chamber.
20. The method of any one of paragraphs 17-19, further comprising disposing a solvent in the at least one decay chamber before said selectively generating gas flow.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. An isotope generator system for producing Pb-212 for Targeted Alpha Therapy (TAT) from a parent isotope, the isotope generator system comprising:
an emanation chamber configured to hold the parent isotope therein;
an isotope collection container; and
an isotope generator including at least one fluid mover and at least one decay chamber, each in selective fluid communication with the emanation chamber and the isotope collection chamber,
wherein the at least one fluid mover is configured to selectively generate gas flow from the emanation chamber to the at least one decay chamber, whereby a gaseous daughter intermediary isotope from the parent isotope in the emanation chamber is entrained in the gas flow and delivered into the decay chamber,
wherein the at least one decay chamber is configured to retain a gaseous intermediary daughter isotope therein to enable decay of the gaseous intermediary daughter isotope to Pb-212 and its daughter isotope,
wherein the at least one fluid mover is configured to selectively generate at least one of gas flow or liquid flow from the at least one decay chamber to the isotope collection chamber to deliver Pb-212 and its daughter isotope in the decay chamber into the isotope collection chamber.

2. The isotope generator system of claim 1, wherein the at least one fluid mover and the at least one decay chamber comprise a piston pump including a reciprocating piston received in a barrel, the barrel functioning as the decay chamber.

3. The isotope generator system of claim 2, wherein the isotope generator includes a piston actuator configured to drive linear, reciprocating movement of the piston within the barrel.

4. The isotope generator system of claim 1, wherein the isotope generator includes a plurality of fluid movers and a plurality of decay chambers.

5. The isotope generator system of claim 4, wherein the isotope generator includes a controller configured to control operation of the plurality of fluid movers to cycle through draw operations, hold operations, and evacuation operations.

6. The isotope generator system of claim 5, wherein the controller is configured to offset timing of operations of the plurality of fluid movers to enable continuous fluid flow through the emanation chamber.

7. The isotope generator system of claim 1, further comprising distribution valve including an inlet port to selectively fluidly connect the emanation chamber and the at least one decay chamber, and an outlet port to selectively fluidly connect the at least one decay chamber and the isotope collection chamber.

8. The isotope generator system of claim 7, further comprising:
inlet check valve downstream of the emanation chamber to inhibit backflow of isotope through the inlet port; and
an outlet check valve downstream of the decay chamber to inhibit backflow of isotope through the outlet port.

9. The isotope generator system of claim 1, wherein the emanation chamber includes a parent isotope coupon comprising a substrate and the parent isotope disposed on at least one surface of the substrate.

10. The isotope generator system of claim 9, wherein the substrate includes an oxide layer on which the parent isotope is disposed to inhibit absorption of the parent isotope and the gaseous intermediary daughter isotope in the substrate.

11. The isotope generator system of claim 1, wherein the parent isotope comprises Radium-224, and the gaseous intermediary daughter isotope comprises Radon-220.

12. An isotope generator for producing an isotope for Targeted Alpha Therapy (TAT) from a parent isotope, the generator comprising:
at least one fluid mover configured to be in selective fluid communication with an emanation chamber holding the parent isotope therein; and
at least one decay chamber in selective fluid communication with the emanation chamber,
wherein the at least one fluid mover is configured to selectively generate gas flow from the emanation chamber to the at least one decay chamber, whereby a gaseous daughter isotope from the parent isotope in the emanation chamber is entrained in the gas flow and delivered into the at least one decay chamber,
wherein the at least one decay chamber is configured to retain a gaseous intermediary daughter isotope therein to enable decay of the gaseous intermediary daughter isotope to the isotope for TAT and its daughter isotope,
wherein the at least one fluid mover is configured to selectively generate fluid flow so that the isotope for TAT and its daughter isotope in the at least one decay chamber is evacuated from the at least one decay chamber.

13. The isotope generator of claim 12, wherein the at least one fluid mover and the at least one decay chamber comprise a piston pump including a reciprocating piston received in a barrel, the barrel functioning as the decay chamber.

14. The isotope generator of claim 12, further comprising a controller configured to control operation of the at least one fluid mover to cycle through draw operations, hold operations, and evacuation operations.

15. The isotope generator of claim 12, further comprising a distribution valve including an inlet port to selectively fluidly connect the emanation chamber and the at least one decay chamber, and an outlet port to selectively fluidly connect the at least one decay chamber to enable evacuation of the isotope for TAT and its daughter isotope from the at least one decay chamber.

16. The isotope generator of claim 12, wherein the at least one fluid mover comprises a plurality of fluid movers and the at least one decay chamber comprises a plurality of decay chambers.

17. A method for producing Pb-212 for Targeted Alpha Therapy (TAT) from a parent isotope, the method comprising:
selectively generating gas flow, using at least one fluid mover, from an emanation chamber holding the parent isotope to at least one decay chamber so that a gaseous intermediary daughter isotope emanating from the parent isotope in the emanation chamber is entrained in the gas flow and delivered into the at least one decay chamber;
retaining the gaseous daughter isotope within the at least one decay chamber for a selective amount of time so that the gaseous daughter isotope decays to Pb-212 and its daughter isotope; and
selectively generating fluid flow, using the at least one fluid mover, from the at least one decay chamber to an isotope collection chamber so that Pb-212 and its daughter isotope in the decay chamber is evacuated from the at least one decay chamber.

18. The method of claim 17, wherein selectively generating gas flow from the emanation chamber to the at least one decay chamber comprises actuating a piston pump to create negative pressure that draws gas through the emanation chamber.

19. The method of claim 17, wherein selectively generating gas flow from the at least one decay chamber to evacuate the Pb-212 and its daughter isotope from the at least one decay chamber comprises actuating a piston pump to create positive pressure that evacuates the at least one decay chamber.

20. The method of claim 17, further comprising disposing a solvent in the at least one decay chamber before said selectively generating gas flow.
